(19) United States
(12) Patent Application Publication
(10) Pub. No.: US 2021/0191150 A1
(43) Pub. Date: Jun. 24, 2021

(54) EYEGLASSES AND EYEGLASSES SUPPORT MEMBER

(71) Applicant: Masato TSUCHIYA, Chiba (JP)

(72) Inventor: Masato TSUCHIYA, Chiba (JP)

(21) Appl. No.: 17/054,358

(22) PCT Filed: Dec. 27, 2018
(86) PCT No.: PCT/JP2018/048068

§ 371 Date: Nov. 10, 2020

(30) Foreign Application Priority Data
May 15, 2018 (JP) 2018-093408
Oct. 16, 2018 (JP) 2018-194772

(51) Int. Cl. G02C 3/02; G02C 5/14; G02C 11/02

(52) U.S. Cl. CPC G02C 3/02; G02C 11/02; G02C 5/14

(57) ABSTRACT

The object of the present invention is to appropriately distribute the load applied by eyeglasses. Provided are eyeglasses that include: a front portion having lenses; a pair of arm portions that extent perpendicularly from both ends of the front portion; a pair of eyeglasses support members that are connected to the arm portions; wherein each of the eyeglasses support members has a zygomatic arch contact portion that comes in contact with a temporal region so as to engage with a zygomatic arch; and a parietal bone support portion that comes in contact with a position on an outer side of the parietal bone and supports the eyeglasses from above.

### TECHNICAL FIELD

The present invention relates to eyeglasses and an eyeglasses support member. The present invention claims the priority of Japanese Patent Application No. 2018-93408 filed on May 15, 2018 and Japanese Patent Application No. 2018-194772 filed on Oct. 16, 2018, and for designated countries that are permitted to be incorporated by reference in the literature, the content of that application is incorporated into this application by reference.

### BACKGROUND ART

Patent Literature 1 describes eyeglasses without nose pads, in which “eyeglasses without nose pads include a front portion and temple body parts attached to the front portion; auxiliary temple pieces are attached to the temple body parts; and the temple body parts and the auxiliary temple pieces are supported by the zygomatic bones and the back of the head.

### CITATION LIST

### Patent Literature

[Patent Literature 1] JP 2015-38608 A

### SUMMARY OF THE INVENTION

### Technical Problem

In general eyeglasses, the lens portion is supported in front of the eyes by applying loads to nose pads and temple tips. Excessive load from the nose pads puts a strain on the skin above the nose.

In the technique described in Patent Literature 1, instead of having no nose pads, the eyeglasses are supported by installing auxiliary temple pieces on the temples. However, one end of the auxiliary temple piece is located just beside the eye, and the appearance when wearing the eyeglasses is not preferable. Moreover, the temple body parts are elastically bent to open and close the eyeglasses, so the eyeglasses are supported in a form of pressing and holding onto the head from both sides, which causes a headache in a case where the elasticity is strong. Even in a case where the elasticity is not strong, a load is applied from one end of the auxiliary temple piece on the side of the eye, which causes a burden on the skin at that location.

In view of the situation described above, an object of the present invention is to appropriately disperse the load of eyeglasses.

### Solution to Problem

In order to solve the problem described above, the eyeglasses according to one form of the present invention include: a front portion having lenses; a pair of arm portions extending substantially perpendicularly from both ends of the front portion; a pair of eyeglasses support members connected to each of the arm portions: wherein each of the pair of eyeglasses support members has a zygomatic arch contact portion that comes in contact with a temporal region so as to engage with a zygomatic arch; and a parietal bone support portion that comes in contact with a position on an outer side of the parietal bone and supports the eyeglasses from above.

Each of the pair of eyeglasses support members may be composed of a long, thin member having the zygomatic arch contact portion at one end and the parietal bone support portion at the other end, and extends diagonally from below to above the arm portion and from the front to the back of the head.

Any of the eyeglasses above, wherein the pair of eyeglasses support members may be connected to each other at each of the parietal bone supports.

Any of the eyeglasses above, further including connecting members that connect the arm portions and the eyeglasses support members; wherein each connecting member has a plurality of fitting portions, and one of the fitting portions and the arm portion are detachably fitted.

Any of the eyeglasses above, further including connecting members that connect the arm portions and the eyeglasses support members; wherein each connecting member may be rotatably provided with respect to the eyeglasses support member.

Any of the eyeglasses above, wherein each eyeglasses support member may have a protrusion on an upper side of the connecting member that protrudes further in a width direction than the connecting member.

Any of the eyeglasses above, wherein each eyeglasses support member may have a covering portion that covers at least a part of an outer surface of the connecting member.

Any of the eyeglasses above, wherein each arm portion may have a detachable member that fits into a fitting portion provided on the connecting member.

Any of the eyeglasses above, wherein each eyeglasses support member may have a hook-shaped member on a surface opposite to the zygomatic arch contact portion.

Any of the eyeglasses above, wherein each arm portion may have a slit extending in a longitudinal direction or a plurality of through holes continuously arranged in the longitudinal direction; and each eyeglasses support member may be fixed at an arbitrary position in a longitudinal direction of the arm portion by a fixing member penetrating through the slit or the through hole.

Any of the eyeglasses above, wherein each eyeglasses support member may be fixed at an arbitrary position in the longitudinal direction of the arm portion by a fixing member penetrating through the slit or the through hole.

Any of the eyeglasses above, wherein each contact member has a plurality of protrusions continuously arranged in the longitudinal direction of the eyeglasses support member.

Any of the eyeglasses above, wherein each contact member protrudes further in the width direction toward the inner side of the eyeglasses support member than the protrusion height of the fixing member.

Eyeglasses support members according to another form of the present invention are eyeglasses support members that connect to arm portions of eyeglasses, and include: a zygomatic arch contact portion that comes in contact with a temporal region so as to engage with a zygomatic arch; and a parietal bone support that comes in contact with a position on an outer side of the parietal bone and supports the eyeglasses from above.

### EFFECT OF THE INVENTION

With the present invention is possible to appropriately distribute a load applied by eyeglasses.

### BRIEF DESCRIPTION OF THE DRAWINGS

FIGS. 1A and 1B are views illustrating an example of the appearance of eyeglasses according to a first embodiment.

FIG. 2 is a view illustrating an example of a perspective view of eyeglasses.

FIGS. 3A to 3C are views illustrating an example of the appearance of eyeglasses when worn on the head.

FIGS. 4A to 4C are views illustrating another example of the appearance of eyeglasses when worn on the head.

FIGS. 5A and 5B are views illustrating an example of the appearance of an eyeglasses support member in a first modification.

FIG. 6 is a view illustrating an example (No. 1) of a perspective view of eyeglasses in a second modification.

FIG. 7 is a view illustrating an example (No. 2) of a perspective view of eyeglasses in a second modification.

FIGS. 8A and 8B are views illustrating an example of the appearance when eyeglasses according to a second embodiment are worn on the head.

FIGS. 9A and 9B are views for explaining in detail the eyeglasses support member according to a second embodiment.

FIGS. 10A and 10B are views for explaining an example of a fitting portion in a second embodiment.

FIGS. 11A and 11B are views (No. 1) illustrating an example of a modification of the eyeglasses support member according to a second embodiment.

FIGS. 12A to 12D are views (No. 2) illustrating an example of a modification of the eyeglasses support member according to a second embodiment.

FIGS. 13A to 13C are views illustrating an example of the appearance of eyeglasses according to a third, fourth and fifth embodiment.

FIGS. 14A and 14B are views (No. 1) illustrating an example of the appearance of conventional eyeglasses without nose pads.

FIGS. 15A and 15B are views (No. 2) illustrating an example of the appearance of conventional eyeglasses without nose pads.

FIG. 16 is a view illustrating an example of a perspective view of eyeglasses according to a sixth embodiment.

FIG. 17 is a view for explaining an example of a fixing member.

FIG. 18 is a view illustrating an example of a right side view of a part of eyeglasses according to a sixth embodiment.

FIG. 19 is a view illustrating an example of a perspective view of eyeglasses in a first modification of a sixth embodiment.

FIG. 20 is a view illustrating an example of a right side view of a part of eyeglasses in a first modification of a sixth embodiment.

FIG. 21 is a view illustrating an example of a perspective view of eyeglasses in a second modification of a sixth embodiment.

FIG. 22 is a view for explaining the eyeglasses support member 400 in a second modification of a sixth embodiment.

FIG. 23 is a view for explaining the inside of the eyeglasses support member in a second modification of a sixth embodiment.

### DESCRIPTION OF THE EMBODIMENTS

Hereinafter, embodiments of the present invention will be described with reference to the drawings.

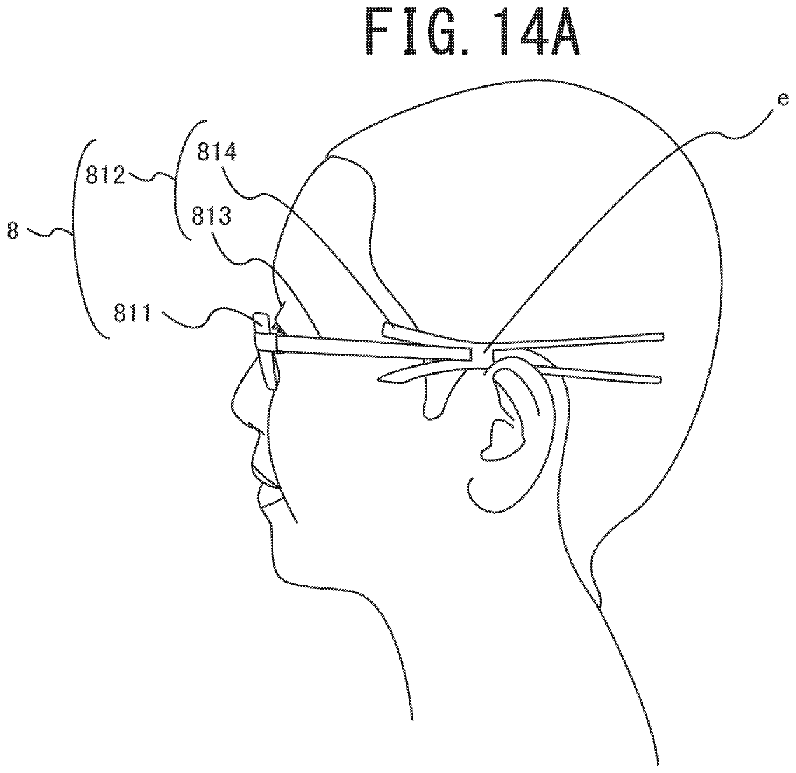

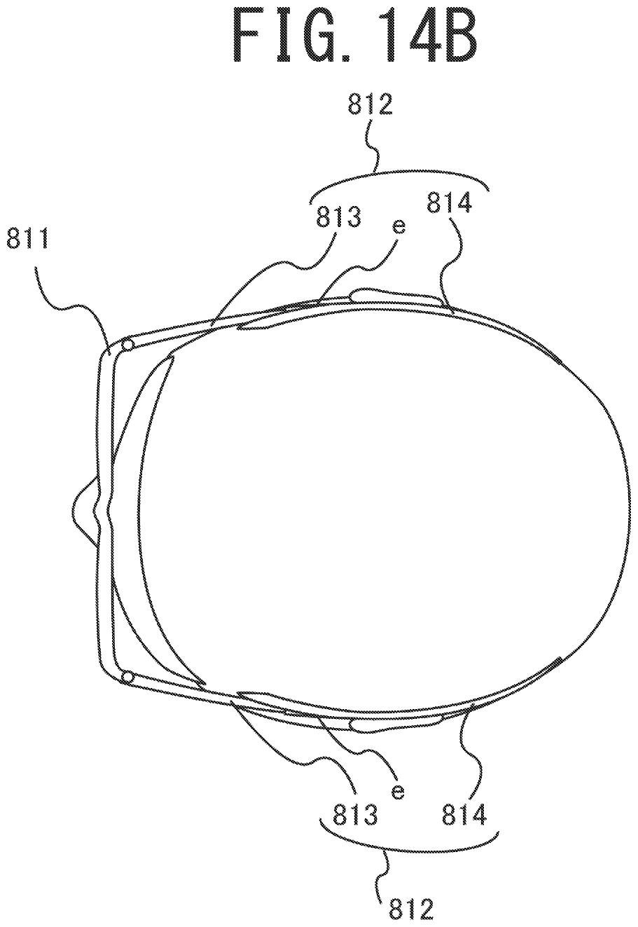

FIGS. 14A and 14B are views (No. 1) illustrating an example of the appearance of conventional eyeglasses 8 without nose pads. FIG. 14A is a right side view of the worn eyeglasses 8, and FIG. 14B is a plan view of the worn eyeglasses 8. The eyeglasses 8 have a front portion 811 and arm portions 812. The front portion 811 is a portion that holds the lenses, and the arm portions 812 are so-called “stems”.

The arm portion 812 has a temple 813 and a temple tip 814. In typical eyeglasses with nose pads, the temple 813 and the temple tip 814 are connected in a straight line, and one end of the temple tip 814 is curved downward and is formed along the curve of the back of the ear. The temple tip 814 of the eyeglasses 8 illustrated in FIGS. 14A, 14B has a shape extending not only toward the rear of the attachment portion e with the temple 813 but also toward the front.

When viewed from above, the temple tips 814 have a curved shape along the head on both the left and right sides, and are formed so as to be in close contact with the side surface of the head. When viewed from the side, the temple tip 814 is divided into two forks at the front and rear of the attachment portion e with the Temple 813. The front of the temple tip 814 comes in contact in the vicinity of the eye orbit so as to be secured by the zygomatic bone. Therefore, the front of the temple tip 814 extends beyond the hairline to the skin portion of the face, and the front of the temple tip 814 is visible when the face is viewed from the front.

In addition, the rear of the temple tip 814 extends toward the rear to the temporal bone. The load previously applied to the nose pads is distributed to the front and rear of the temple tip 814.

In this embodiment, the eyeglasses 8 are supported by the temple tips 814 pressing against and holding onto the head from the left and right, so a load is applied from the front of the temple tips 814 located on the skin portion of the face, which causes a burden on that skin portion. Moreover, the front portions of the temple tips 814 are located at positions so as to be visible when looking at the face, which also hinders the appearance.

Furthermore, in a case where the zygomatic bone of the user does not have a shape that supports the front of the temple tips 814, or in a case where the temple tips 814 apply weak to press against and hold onto the head, the eyeglasses 8 slide downward. On the other hand, in a case where the temple tips 814 apply a strong force to press against and hold onto to the head, there is a possibility that headaches may occur.

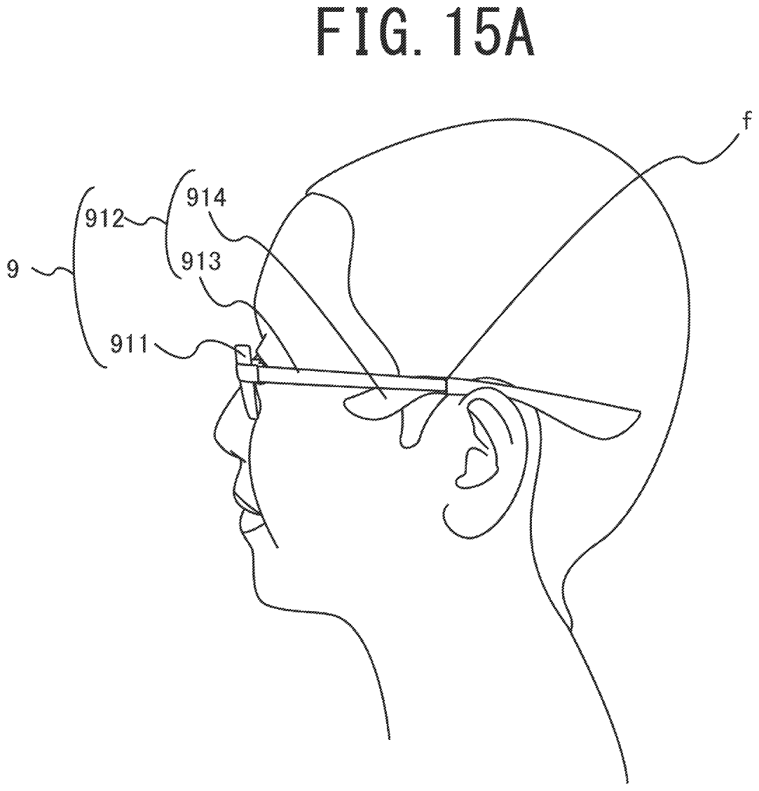

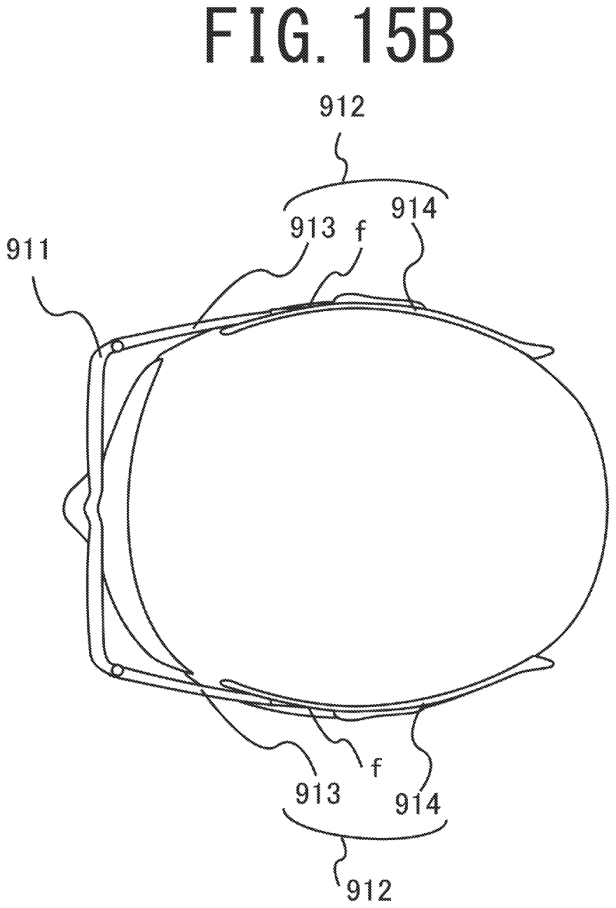

FIGS. 15A and 15B are views (No. 2) illustrating an example of the appearance of conventional eyeglasses 9 without nose pads. FIG. 15A is a right side view of the worn eyeglasses 9, and FIG. 15B is a plan view of the worn eyeglasses 9. The eyeglasses 9 have a front portion 911 and arm portions 912. The front portion 911 is a portion having lenses, and the arm portions 912 are “stems”.

The arm portion 912 has a temple 913 and a temple tip 914. Similar to the temple tips 814 illustrated in FIGS. 14A and 14B, the temple tip 914 of the eyeglasses 9 illustrated in FIG. 15 has a shape extending not only toward the rear but also toward the front of the attachment portion f of the temple 913. Note that the front and rear of the temple tip 914 are different from those of the eyeglasses 8 in that they are not divided into two forks.

Similar to the temple tip 814 in FIGS. 14A and 14B, the front of the temple tip 914 extends to the vicinity of the eye orbit so as to be secured by the zygomatic bone, and the front of the temple tip 914 is visible when the face is viewed from the front. In addition, the rear of the temple tips 914 extend toward the rear of the temporal bones, and the eyeglasses 9 are such that by the left and right temple tips 914 pressing against and holding onto the head therebetween, the front portion 911 is supported in front of the eyes. However, as in the case of the eyeglasses 8 illustrated in FIGS. 14A and 14B, the eyeglasses 9 may slide downward when conditions are not met. In particular, when the center of gravity of the eyeglasses 8 or the eyeglasses 9 is closer to the front portions 811 and 911, there is a high possibility that the front portions 811 and 911 will not be supported and fall downward.

### First Embodiment

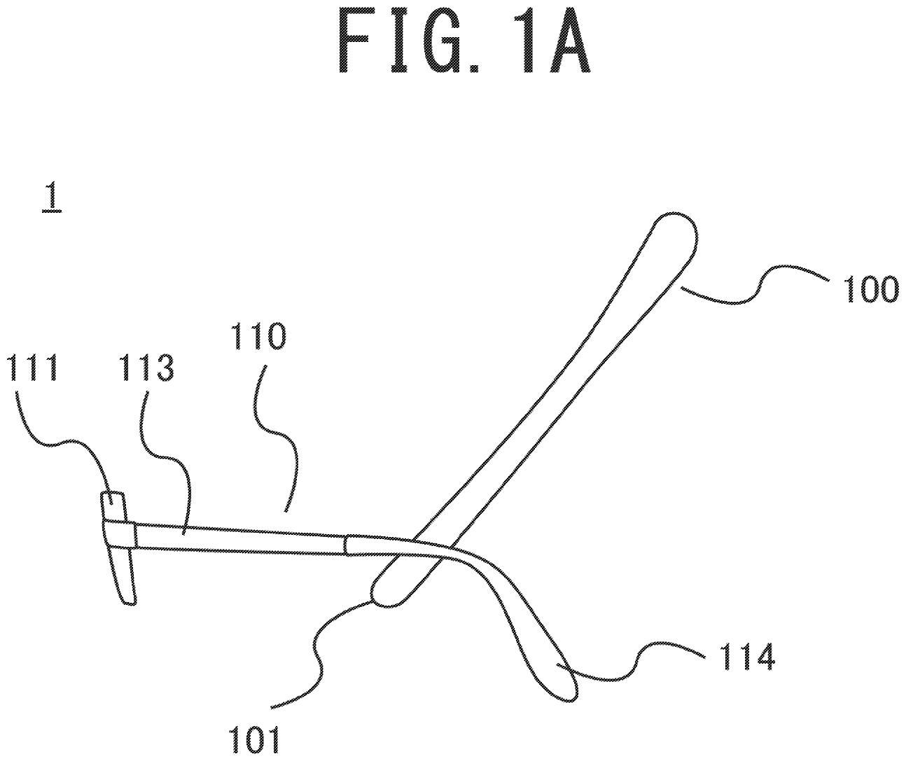

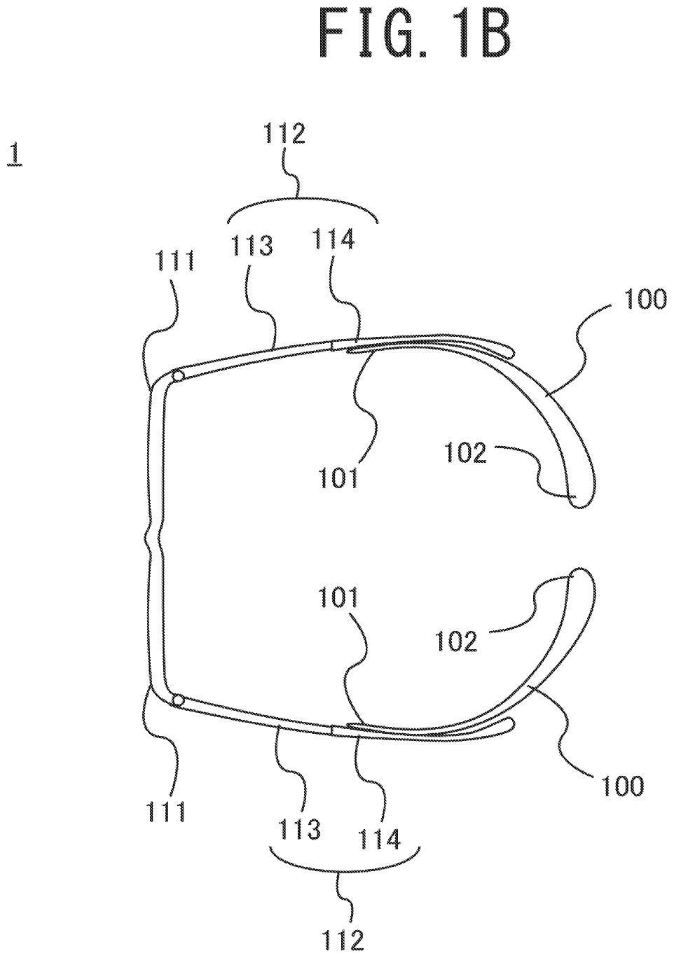

FIGS. 1A and 1B are views illustrating an example of the appearance of eyeglasses 1 according to a first embodiment. FIG. 1A is an example of a right side view of the eyeglasses 1, and FIG. 1B is an example of a plan view of the eyeglasses 1. The eyeglasses 1 have eyeglasses support members 100 and an eyeglasses main body portion 110.

The eyeglasses main body portion 110 has a front portion 111 having lenses and a set of arm portions 112 extending substantially vertically from both ends of the front portion 111. The front portion 111 is provided with one or more lenses. Preferably, the front portion 111 does not have nose pads.

The arm portions 112 have a temple 113 and a temple tip 114. The temple 113 is made of metal, resin, or the like. The temple tip 114 is a member that comes into contact with the upper portion of the base of the outer ear, and is formed of a resin such as silicon, rubber, or the like. The temple tip 114 may be integrated with the temple 113, and the material of the temple 113 and the temple tip 114 is not limited.

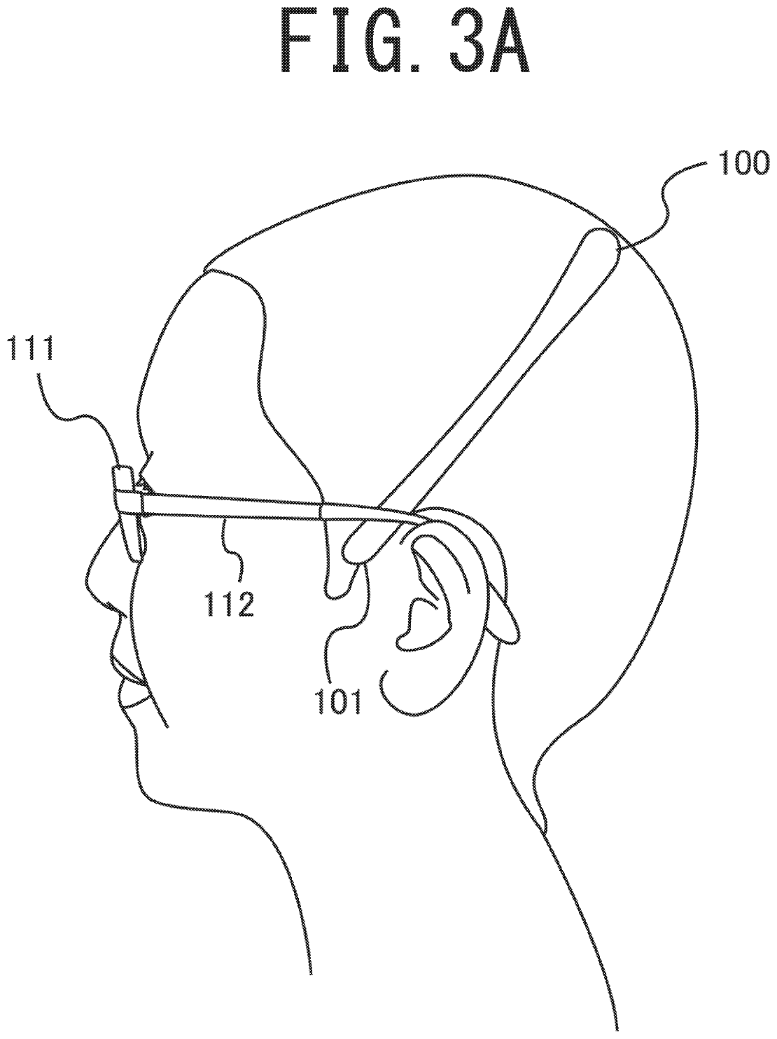

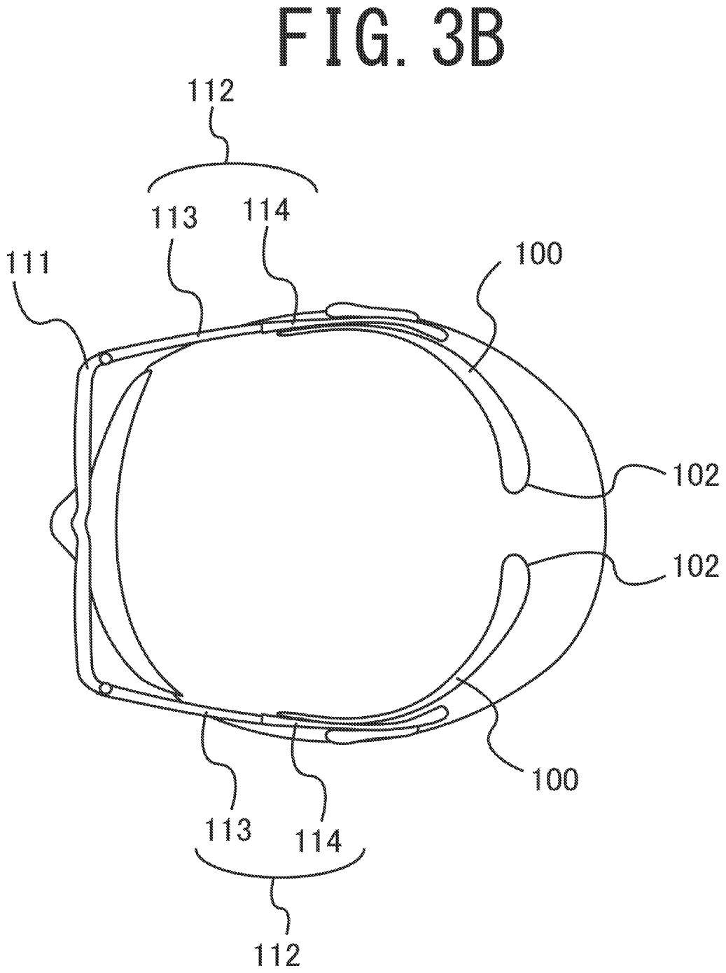

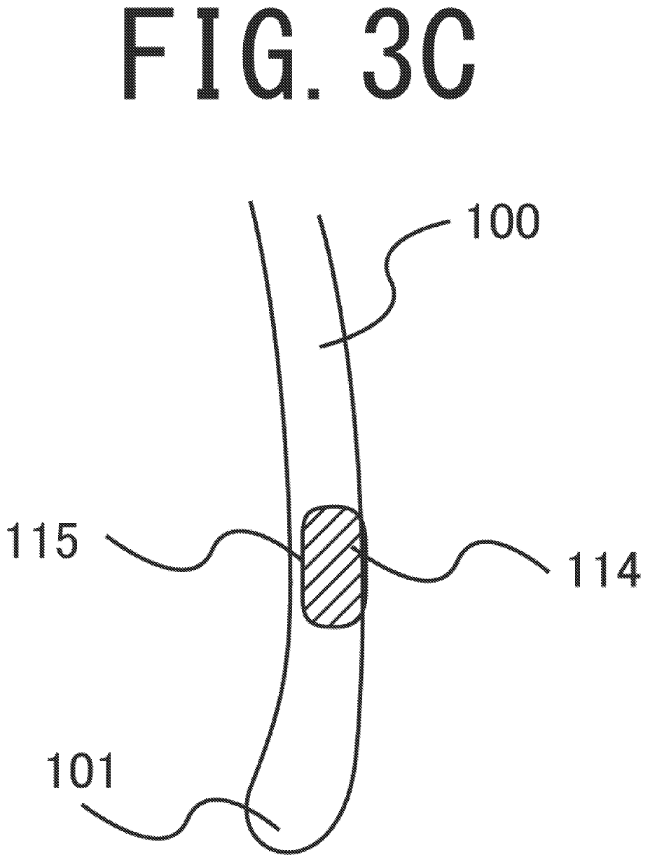

The eyeglasses support member 100 is a set of members connected to each arm portion 112, and each has a zygomatic arch contact portion 101 and a parietal bone support portion 102. As an example, the eyeglasses support member 100 is composed of a pair of long, thin members having a zygomatic arch contact portion 101 at one end and a parietal bone support portion 102 at the other end. When worn on the head, the eyeglasses support member 100 extends in a direction from below to above the arm portion 112, and extends in a direction from the front toward the rear of the head. In addition, the eyeglasses support member 100 has a curved shape that curves inward along the head (see FIGS. 3A to 3C).

As an example, the eyeglasses support member 100 is partially or entirely formed of resin. However, the material of the eyeglasses support member 100 is not limited to this.

The zygomatic arch contact portion 101 is provided on the inside of the eyeglasses support member 100 (the side that comes in contact with the head) and comes in contact the temporal region. The zygomatic arch is a bone that extends substantially horizontally toward the outside of the eye orbit. The zygomatic arch contact portion 101 comes in contact with the temporal region so as to engage with the zygomatic arch.

The parietal bone support portion 102 is provided inside the eyeglasses support member 100 and comes in contact with an outer position of the parietal bone to support the eyeglasses 1 from above. As an example, the parietal bone support portion 102 has a surface that extends in close contact along the surface of the head (including the scalp and hair) located on the outside of the parietal bone when worn, and applies a load to the surface of the head in a direction from top to bottom. As a result, the parietal bone support portion 102 supports the eyeglasses 1 from above.

The eyeglasses support member 100 is connected to the temple tip 114 or the temple 113 in the vicinity of the zygomatic arch contact portion 101 or above the zygomatic arch contact portion 101. Hereinafter, an example in which the eyeglasses support member 100 is connected to the temple tip 114 will be described. The eyeglasses support member 100 and the temple tip 114 may be rotatably or detachably connected, or may be fixed so as not to be detached or rotated. The eyeglasses support member 100 and the temple tip 114 may also be integrally molded.

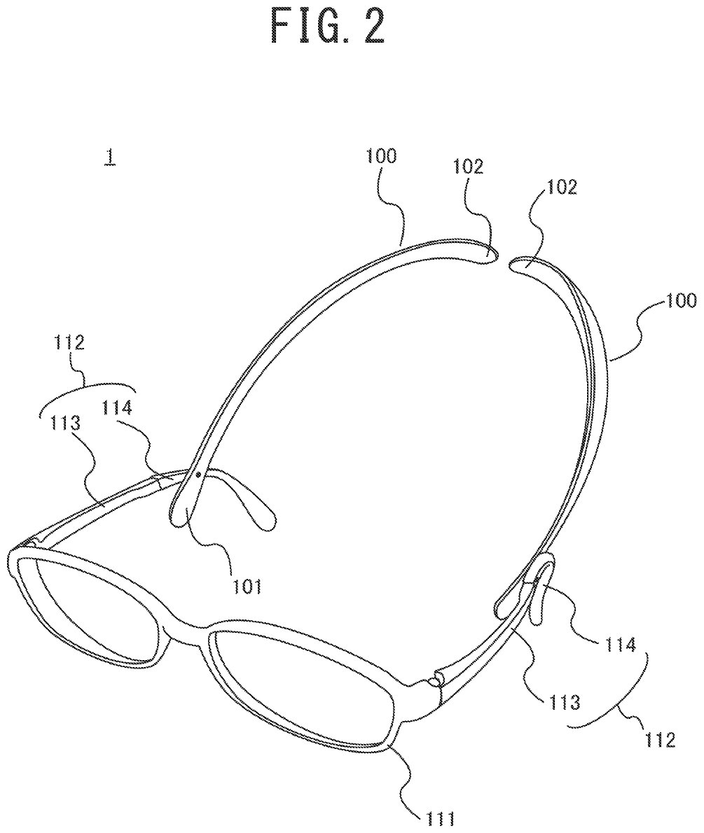

FIG. 2 is a view illustrating an example of a perspective view of eyeglasses 1. The pair of eyeglasses support members 100 have a left-right symmetrical shape. The eyeglasses support members 100 in this example is located on the inner side of the temple tip 114. In FIG. 2, the eyeglasses support member 100 and the temple tip 114 are connected by a small screw; however, the method of connecting the eyeglasses support member 100 and the temple tip 114 is not limited to this.

The inner surface of the eyeglasses support member 100 may have a shape having a plurality of grooves having a non-slip function. The grooves may be provided over the entire inner surface of the eyeglasses support member 100. In addition, comb teeth for securing the eyeglasses support member 100 to the hair may be provided on all or a part of the inner surface of the eyeglasses support member 100. The comb teeth may be provided so as to stand erect on the inner surface of the eyeglasses support member 100. The comb teeth may also be provided so as to extend from the rear side surface or the front side surface of the eyeglasses support member 100 toward the rear or front of the user.

Moreover, the eyeglasses support member 100 does not have to have a linear shape as illustrated in FIG. 1A when viewed from the side, and may have a wavy shape in the front-rear direction. In addition, the eyeglasses support member 100 may have a jagged shape having a plurality of corners such as saw blades in the front and rear. Furthermore, the eyeglasses support member 100 may be shaped like an elongated ring when viewed from the side.

By increasing the contact area with the surface of the head as compared with the case of a linear shape, it is possible to prevent the eyeglasses support member 100 from becoming displaced from the surface of the head. Moreover, by increasing the degree of freedom in the shape, the design becomes more diverse and the design is improved.

FIGS. 3A to 3C are views illustrating an example of the appearance of eyeglasses when worn on the head. FIG. 3A is an example of a right side view of the eyeglasses 1 when worn on the head, and FIG. 3B is an example of a plan view of the eyeglasses 1 when worn on the head. FIG. 3C is an example of a front view of the zygomatic arch contact portion 101 of the eyeglasses support member 100 located on the left side of the person wearing the eyeglasses 1. FIG. 3C illustrates only a cross section of the temple tip 114, and the other parts of the temple tip 114 are not illustrated.

As illustrated in FIG. 3 (A), as a result of coming in contact with the temporal region so as to engage with the zygomatic arch, the zygomatic arch contact portion 101 is located further on the rear side than the general hairline. In addition, the eyeglasses support member 100 extends at an incline in a direction from below to above the arm portion 112 and from the front toward the rear of the head. Furthermore, as is evident from FIGS. 3 (A) and 3 (C), the eyeglasses support member 100 in this example is located further on the inner side (head side) than the temple tip 114. The eyeglasses support member 100 in this example has a recess 115 having front and rear openings on the outer surface, and the eyeglasses support member 100 and the temple tip 114 are connected by fitting a part of the temple tip 114 into the recess 115.

Note that the eyeglasses 1 according to the present embodiment have eyeglasses support members 100 extending to the parietal bone, so that the center of gravity is located at the rear side as compared with the eyeglasses having no eyeglasses support members 100. With this configuration, the front portion 111, which tends to apply a load because of having the lenses, is appropriately held in front of the eyes. This is especially useful in a case of eyeglasses 1 that do not have node pads.

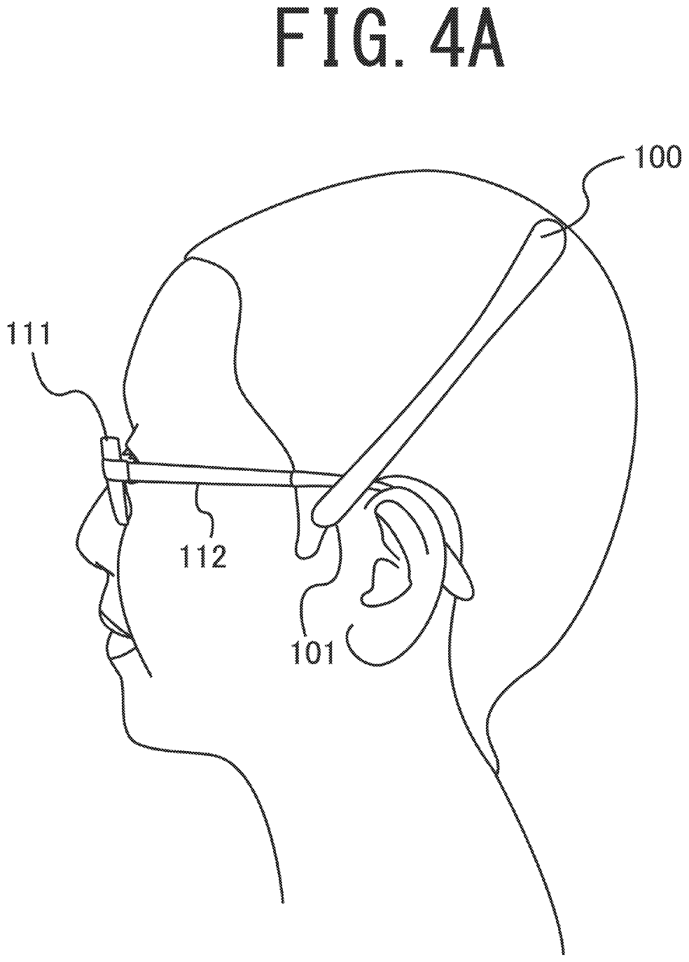

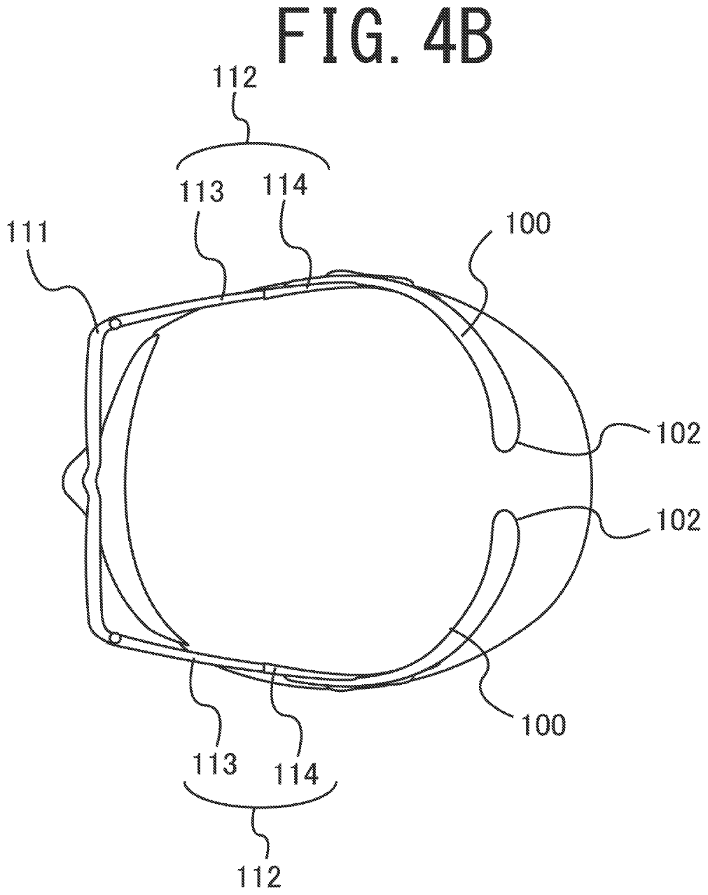

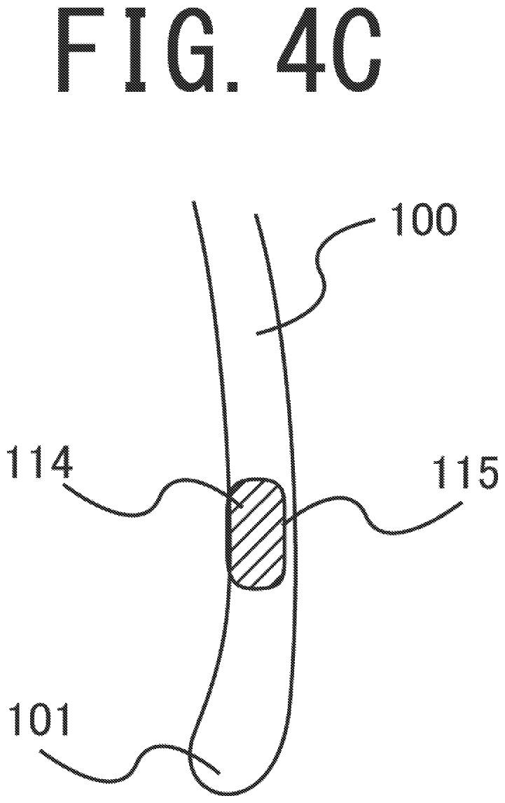

FIGS. 4A to 4C are views illustrating an example of the appearance of eyeglasses 1 when worn on the head. FIG. 4A is a right side view of another example of eyeglasses 1 when worn on the head, and FIG. 4B is a plan view of another example of eyeglasses 1 when worn on the head. FIG. 4C is another example of a front view of the zygomatic arch contact portion 101 of the eyeglasses support member 100 located on the left side of the person wearing the eyeglasses 1. FIG. 4C illustrates only the cross section of the temple tip 114 as in the case of FIG. 3C, and the other parts of the temple tip 114 are not illustrated.

In this example, the eyeglasses support member 100 has a recess 115 on the inner side surface, and the eyeglasses support member 100 and the temple tip 114 are connected by fitting a part of the temple tip 114 into the recess 115. In order to maintain an appropriate distance between the temple tip 114 and the head, the zygomatic arch contact portion 101 of the eyeglasses support member 100 may have a shape bulging further inward than illustrated in FIG. 4 (C).

### First Modification

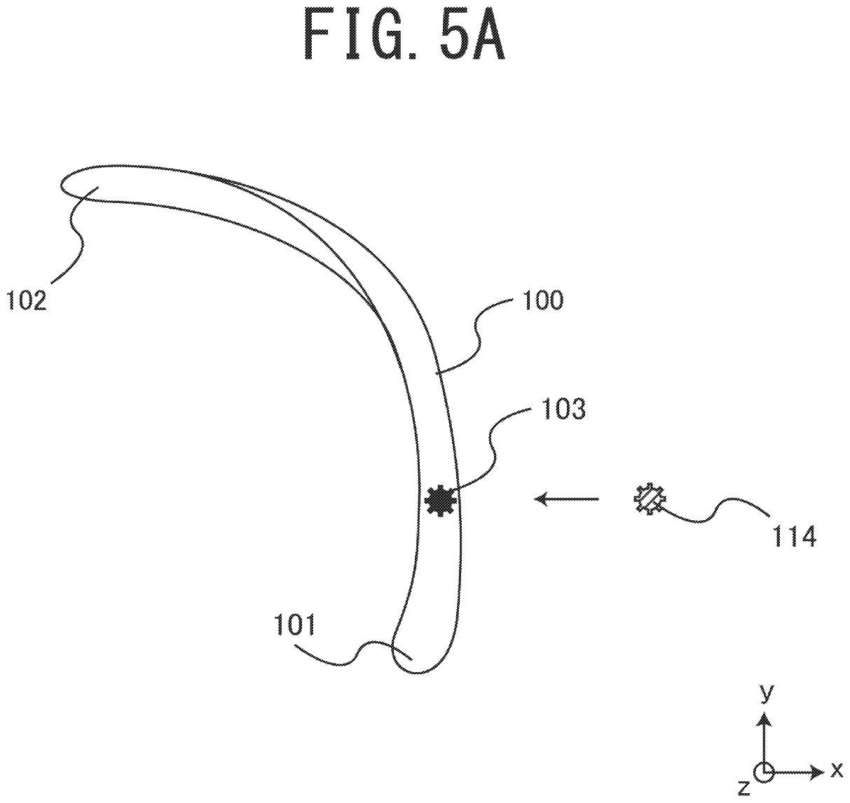

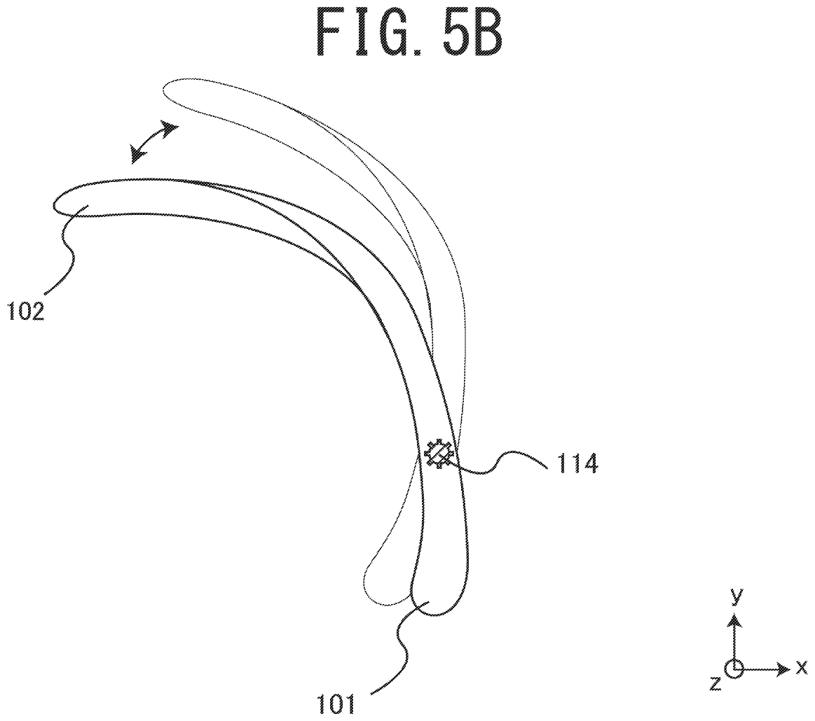

FIGS. 5A and 5B are views illustrating an example of the appearance of an eyeglasses support member 100 in a first modification. FIG. 5A is an example of a view as seen from the front of the eyeglasses support member 100 located on the left side of the person wearing the eyeglasses 1 in the first modification. FIG. 5B is a diagram illustrating a usage state of the eyeglass support member 100 illustrated in FIG. 5A. Hereinafter, points that differ from the embodiments described above will be described. Note that unless otherwise specified, each of the pair of eyeglass support members 100 has a left-right symmetrical shape. Moreover, the x-axis indicates the left-right direction of the head, the y-axis indicates the vertical direction of the head, and the z-direction indicates the front-back direction of the head. The same applies to other figures as well.

The eyeglasses support member 100 has a through hole 103 and the temple 113 or the temple tip 114 penetrates through the through hole 103. In the example illustrated in FIGS. 5A and 5B, the temple tip 114 penetrates through the through hole 103. The through hole 103 may have a plurality of recesses on the inner peripheral surface thereof, and the temple tip 114 may have a plurality of protrusions on the outer peripheral surface thereof, each of which may into the recess.

By fitting together the recesses of the through hole 103 and the protrusions of the temple tip 114, the rotation angle of the eyeglasses support member 100 about the axis of the temple tip 114 is determined. In other words, taking an axis parallel to the z-axis illustrated in FIG. 5 (A) or FIG. 5 (B) (in other words, an axis corresponding to the temple tip 114) to be a p-axis, the rotation angle of the eyeglasses support member 100 about the p-axis is determined. In a case where the eyeglasses 1 are worn on the head, and in a case where the wearability is not preferable such as when there is insufficient adhesion between the parietal bone support portion 102 and the head, the rotation angle of the eyeglasses support member 100 may be adjusted by fitting the protrusions of the temple tip 114 into other recesses of the through hole 103. Note that it is also possible for the through hole 103 to have protrusions, and the temple tip 114 to have recesses.

Note that the eyeglasses 1 are not limited to this structure as long as the rotation angle of the eyeglasses support member 100 about the axis of the temple tip 114 can be fixed. For example, the structure may be such that the through hole 103 has claws on the inner peripheral surface that are hooked on the protrusions of the temple tip 114, which prevents rotation in one direction (for example rotation to the right in FIG. 5A or FIG. 5B), and allows rotation in the opposite direction.

### Second Modification

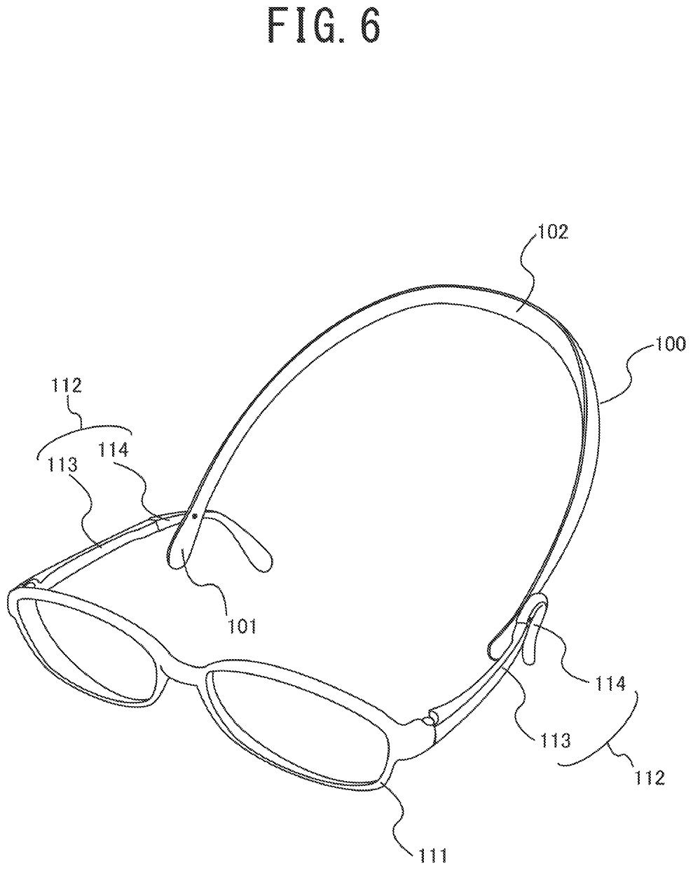

FIG. 6 is a view illustrating an example (No. 1) of a perspective view of eyeglasses 1 in a second modification. In this modification, the pair of eyeglasses support members 100 are connected to each other by their respective parietal bone support portions 102. In other words, the eyeglasses support member 100 is a long, thin member that has a zygomatic arch contact portion 101 on one end that comes in contact with temporal region on the right side and a zygomatic arch contact portion 101 on the other end that comes in contact with the temporal region on the left side. The eyeglasses support member 100 has a parietal bone support portion 102 near the center.

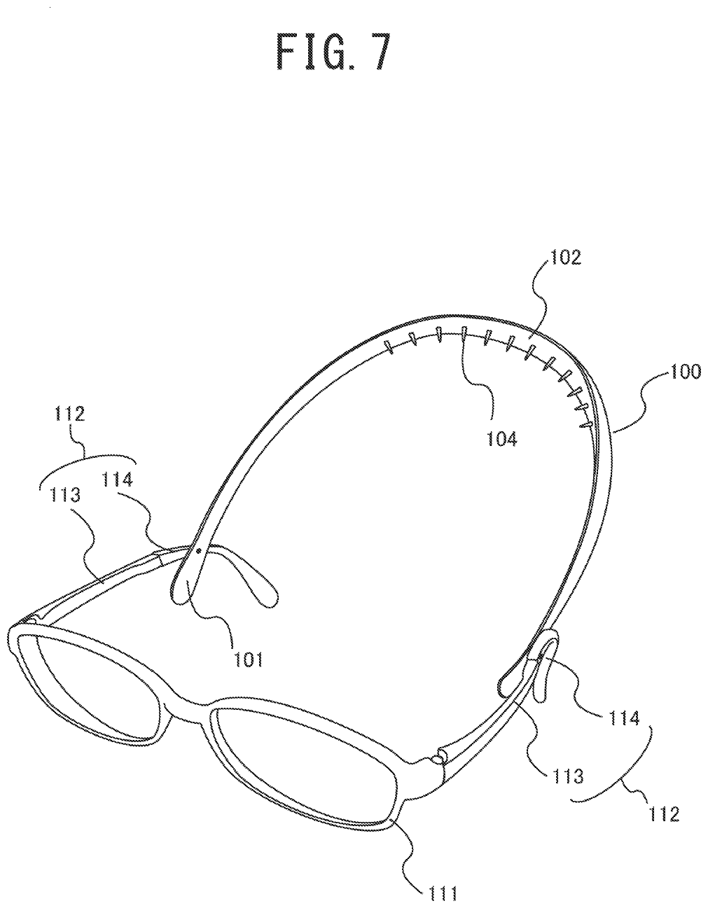

FIG. 7 is a view illustrating an example (No. 2) of a perspective view of eyeglasses 1 in a second modification. As illustrated in FIG. 7, the eyeglasses support member 100 in the second modification may have one or a plurality of protrusions 104 on the inner side surface. The contact between the protrusions 104 and the hair makes it easier for the eyeglasses support member 100 to be secured near the outer side of the parietal bone.

Note that the eyeglasses support member 100 of the eyeglasses 1 in the second modification does not have to have a linear shape when viewed from the side, and needless to say, may have a wavy shape in the front-rear direction, or may have a shape in which there is plurality of corner portions such as saw blades in the front-rear direction.

### Second Embodiment

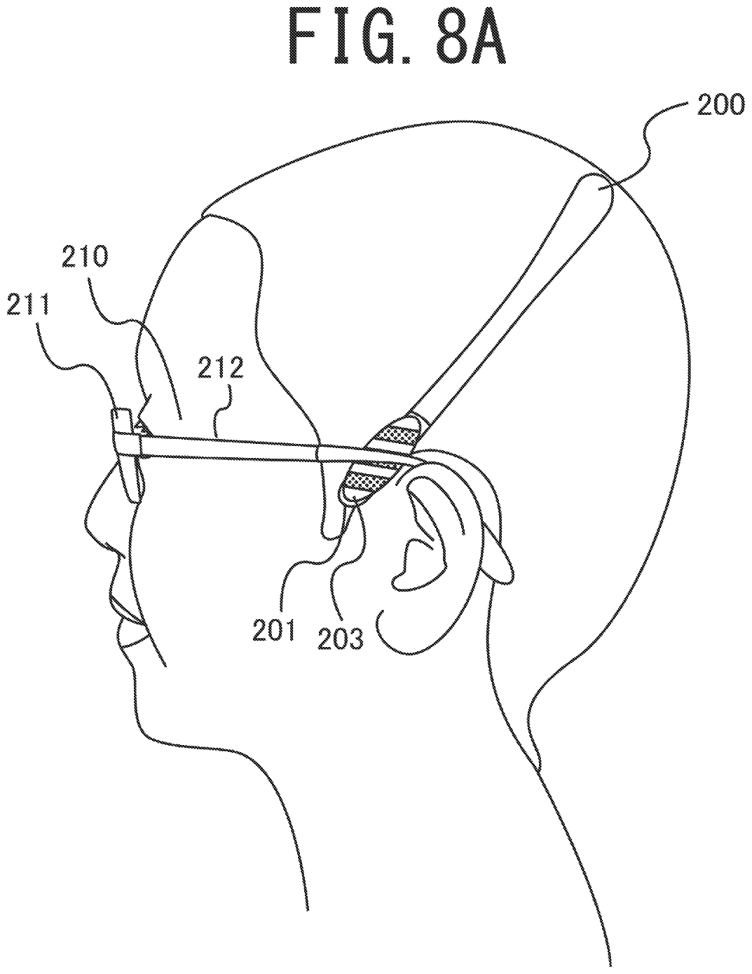

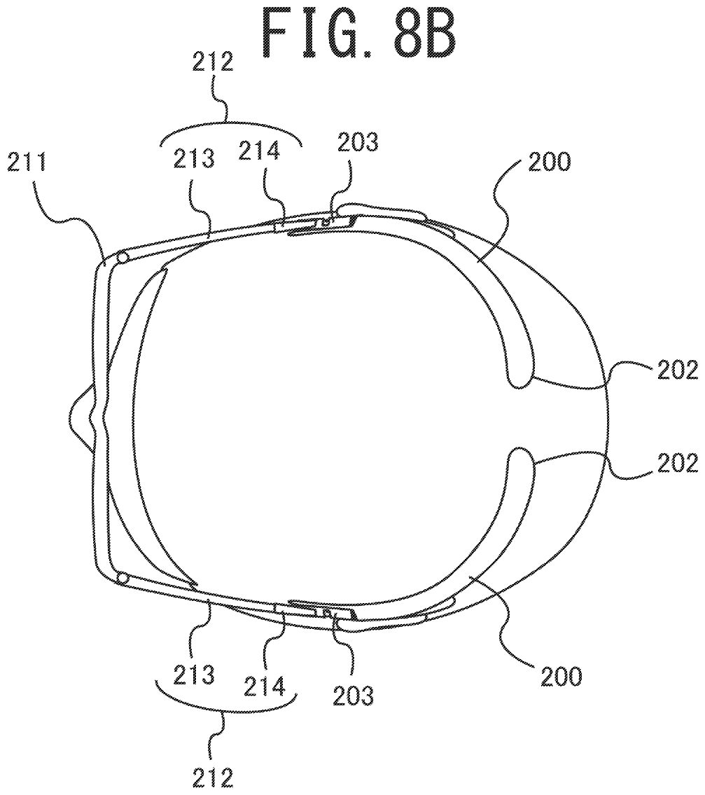

FIGS. 8A and 8B are views illustrating an example of the appearance when eyeglasses 2 according to a second embodiment are worn on the head. FIG. 8A is an example of a right side view when the eyeglasses 2 according to this second embodiment are worn on the head, and FIG. 8B is an example of a plan view when the eyeglasses 2 according to this second embodiment are worn on the head. Hereinafter, points that differ from the first embodiment described above will be described.

The eyeglasses 2 have eyeglasses support members 200 and an eyeglasses main body portion 210. The eyeglasses main body portion 210 has a front portion 211 and arm portions 212, and the arm portions 212 have temples 213 and temple tips 214. The eyeglasses support member 200 is different from the first embodiment in that, together with having a zygomatic arch contact portion 201 and a parietal bone support portion 202, also has a connecting member 203.

In the example illustrated in FIGS. 8A and 8B, the connecting member 203 is provided on the outer side of the eyeglasses support member 100. Note that the connecting member 203 in FIGS. 8A and 8B has an elliptical shape when viewed from the side of the user; however, the shape of the connecting member is not limited to this. The shape may also be circular or polygonal.

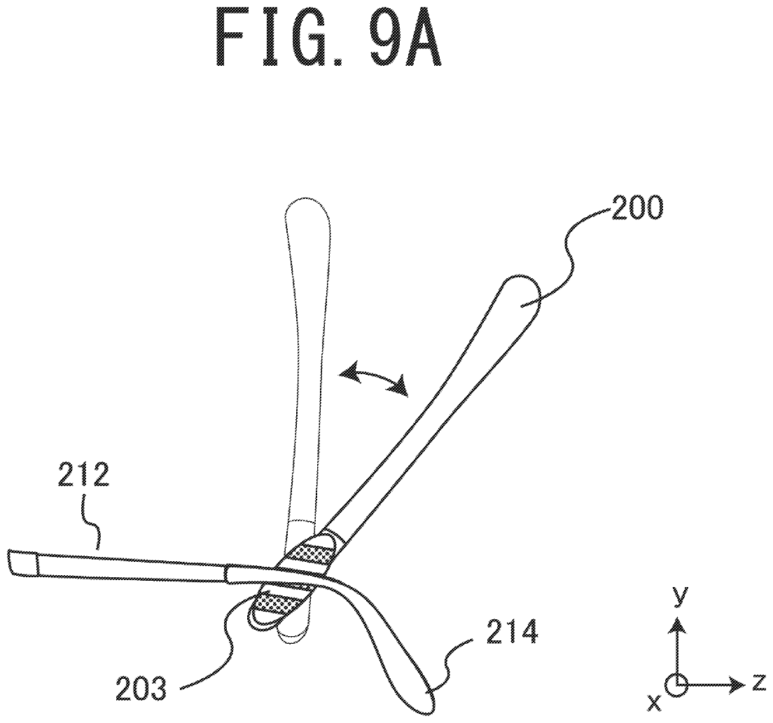

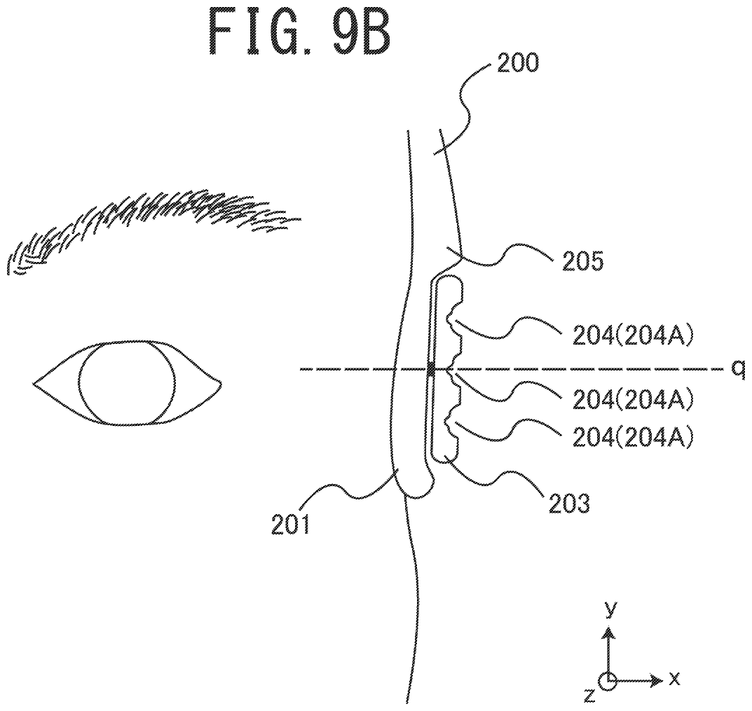

FIGS. 9A and 9B are views for explaining in detail the eyeglasses support member 200 according to this second embodiment. FIG. 9A is an example of a view of the eyeglasses support member 200 and the arm portion 212 located on the left side of the user when worn, as viewed from the left side, and FIG. 9B is a front view of a part of the eyeglass support member 200.

The connecting member 203 has a plurality of fitting portions 204, and any one of the fitting portions 204 and the arm portion 212 are detachably fitted to each other. The connecting member 203 is provided so as to be able to rotate with respect to the eyeglasses support member 200. Presuming that the axis parallel to the x-axis illustrated in FIGS. 9A and 9B is a q-axis, the eyeglasses support member 200 is able to rotate about the q-axis with respect to the connecting member 203. In other words, the arm portion 212 is fixed by wearing the eyeglasses 2, and the connecting member 203 that fits with the arm portion 212 is also fixed in the same manner; however, it becomes possible for the eyeglasses support member 200 to rotate about the q-axis with respect to the connecting member 203.

The connecting member 203 has a plurality of fitting portions 204 having different heights. The connecting member 203 illustrated in FIGS. 9A and 9B is located on the outer side of the zygomatic arch contact portion 201, and has three fitting portions 204 that are recessed outward. The fitting portion 204 has a recess in substantially the center when viewed from the front that is recessed more than the other portions. That shape is referred to as the fitting portion 204A, and the shape of the fitting portion 204 will be described later. Note that in the example illustrated in FIGS. 9A and 9B, the fitting portion 204 is provided on the surface of the outer side of the connecting member 203; however, the fitting portion 204 may also be provided on the surface of the inner side (the surface on the head side) of the connecting member 203. The same applies to the modifications illustrated below.

Moreover, the eyeglasses support member 200 in this second embodiment has a protrusion 205 on the upper side of the connecting member 203 that protrudes in the width direction (the left-right direction of the user, or in other words, the x-axis direction in FIG. 9B) from the connecting member 203. In a case where there is a gap between the main body portion of the eyeglasses support member 200 and the connecting member 203, the protrusion 205 prevents hair from entering the gap. In addition, the protrusion 205 prevents hair from entering between the fitting portion 204 and the temple tip 214.

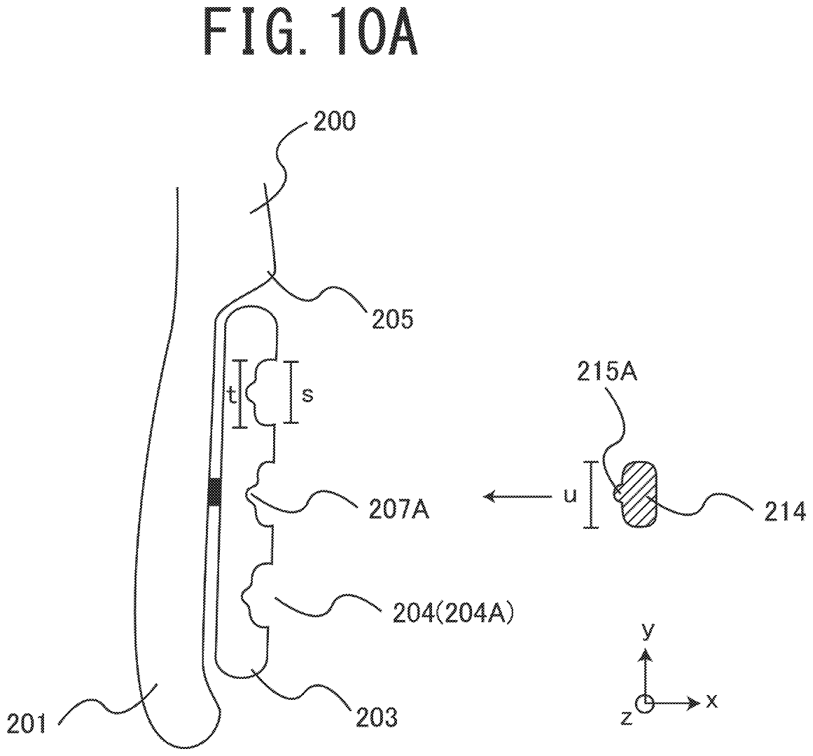

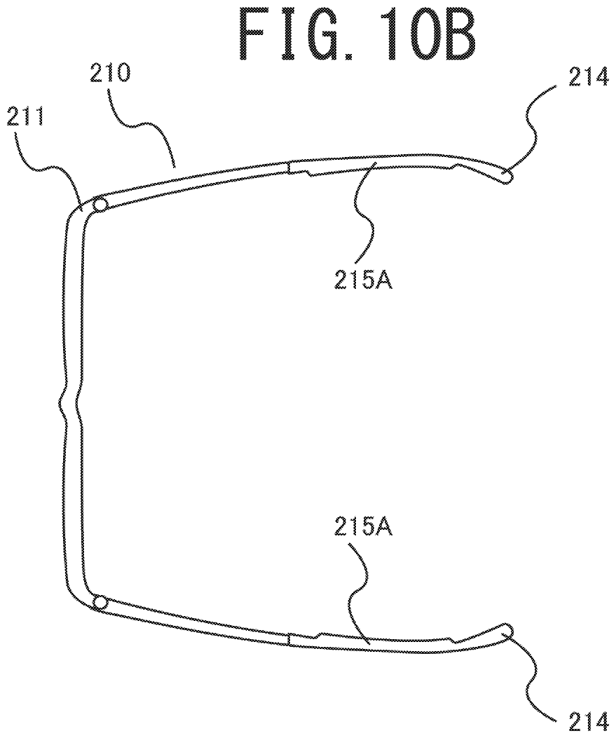

FIGS. 10A and 10B are views for explaining an example of a fitting portion 204A in this second embodiment. FIG. 10A is a front view illustrating a part of the eyeglasses support member 200 and the cross section of the connecting member 203 located on the left side of the user when worn. The fitting portion 204A extends in the z direction, and both ends thereof are open. Moreover, the fitting portion 204A has a recess 207A. The recess 207A is a portion further recessed on the bottom surface of the fitting portion 204A and having a recessed shape with respect to the connecting member 203. On the other hand, the temple tip 214 has a protrusion 215. The protrusion 215 fits into the recess 207A to further strengthen the connection between the connecting member 203 and the temple tip 214.

FIG. 10B is an example of a plan view of the eyeglasses main body portion 210. The protrusion 215 of the temple tip 214 of the eyeglasses main body portion 210 protrudes inward so as to fit into the recess 207A, and extends to the front and rear. The protrusion 215 may be detachable with respect to the temple tip 214. In that case, the protrusion 215 may be integrally molded with, for example, a resin cylinder that is removable from the temple tip 214.

As described above, the fitting portion 204A may also be provided on the surface of the inner side of the connecting member 203. In that case, the protrusion 215 of the eyeglasses 2 protrudes outward.

The surface on the inner side of the temple tip 214 is brought into contact with the upper and lower edges of the opening portion in the x direction of the fitting portion 204A, and by applying a constant force, the temple tip 214 is fitted with and fixed to the fitting portion 204A. Note that it is desirable that the dimension s in the height direction of the opening portion of the fitting portion 204A is smaller than the dimension tin the height direction of the inner portion of the fitting portion 204A and the dimension u in the height direction of the temple tip.

The temple tip 214 may be fitted with each of a plurality of fitting portions 204A having different heights, so the temple tip 214 may be fitted by selecting a fitting portion 204A having a preferable height at the time of fitting. In addition, the fitting portion 204A extends in the z direction, so the position of the temple tip 214 (in other words, the arm portion 212) may be adjusted by shifting as necessary.

Note that instead of having the fitting portion 204, the connecting member 203 may have one or a plurality of through holes as illustrated in FIGS. 5A and 5B. The through hole of the connecting member 203 extends in the z direction in FIGS. 5A and 5B in the same manner as that illustrated in FIGS. 5A and 5B. By causing the arm portion 212 to penetrate through the through hole, not only the rotation angle about the q-axis illustrated in FIGS. 9A and 9B, but also the rotation angle about the arm portion 212 may be adjusted.

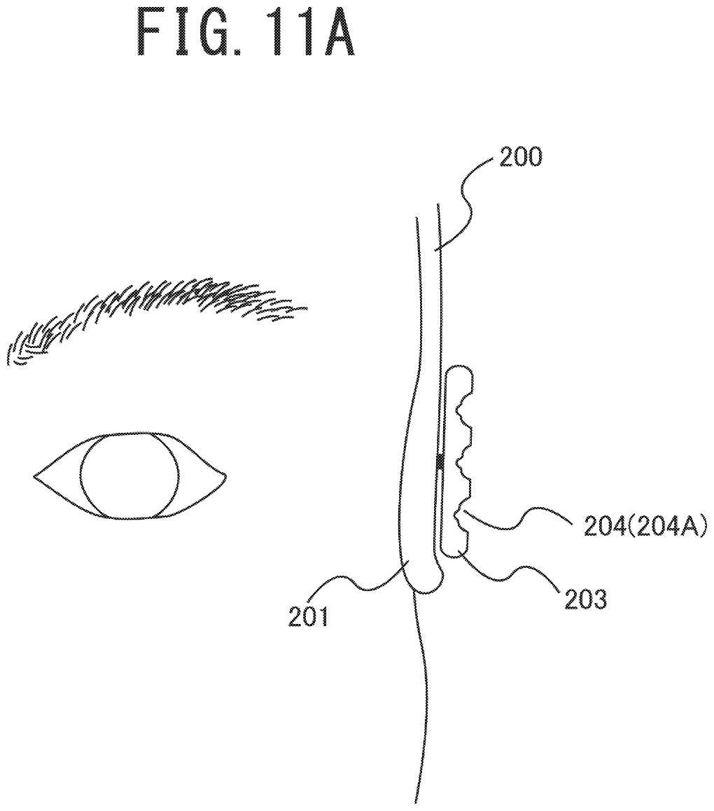

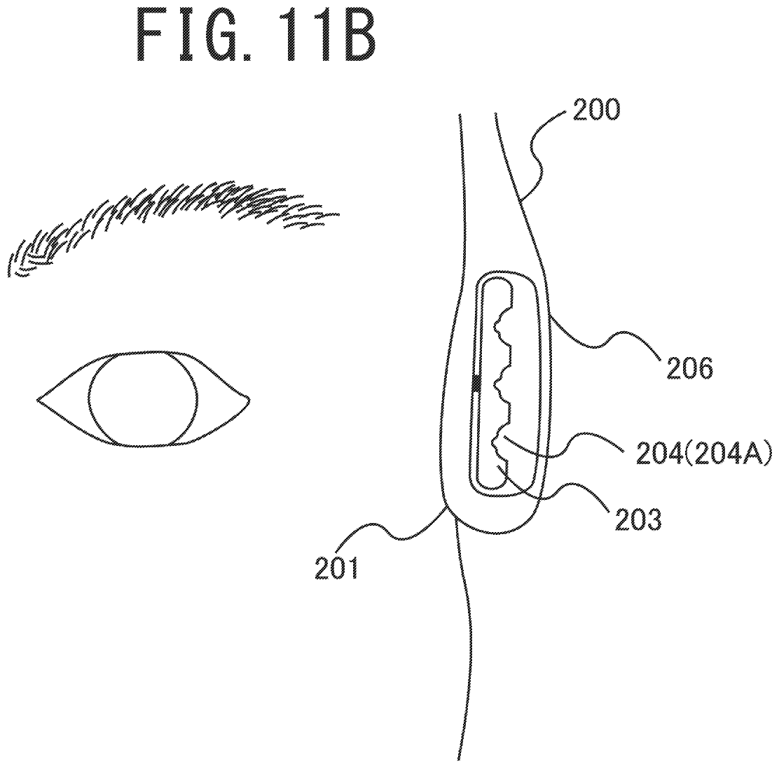

FIGS. 11A to 11B are views (No. 1) illustrating an example of a modification of the eyeglasses support member 200 according to a second embodiment.

### First Modification

FIG. 11A is a view illustrating a first modification of the eyeglasses support member 200 according to the second embodiment. FIG. 11A is a front view illustrating a part of the eyeglasses support member 200 located on the left side of the user when worn. The eyeglasses support member 200 in this modification does not have a protrusion 205.

### Second Modification

FIG. 11B is a view illustrating a second modification of the eyeglasses support member 200 according to the second embodiment. FIG. 11B is a view illustrating the front of a part of the eyeglasses support member 200 in the second embodiment that is located on the left side of the user when worn. The eyeglasses support member 200 in this modification has a covering portion 206 that covers at least a part of the outer surface of the connecting member 203.

In a case where there is a gap between the connecting member 203 and the main body portion of the eyeglasses support member 200, the gap is covered by the covering portion 206, and it is possible to prevent hair from entering the gap. Moreover, the fitting portion 204 is covered, so not only is hair or the like prevented from entering the fitting portion, a neat impression is also given to the appearance.

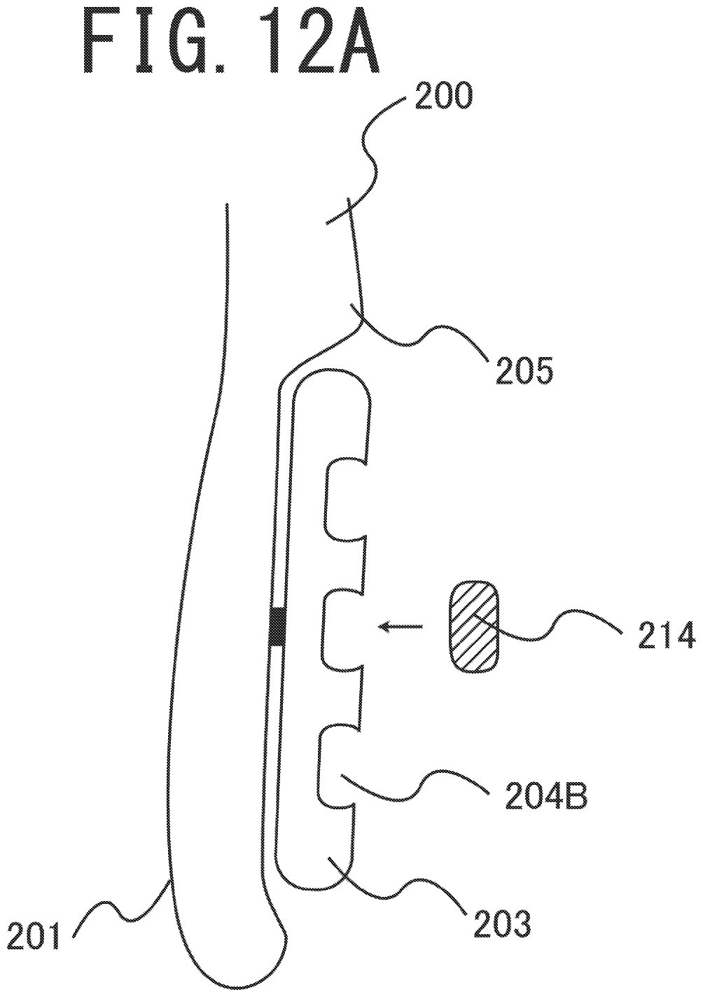

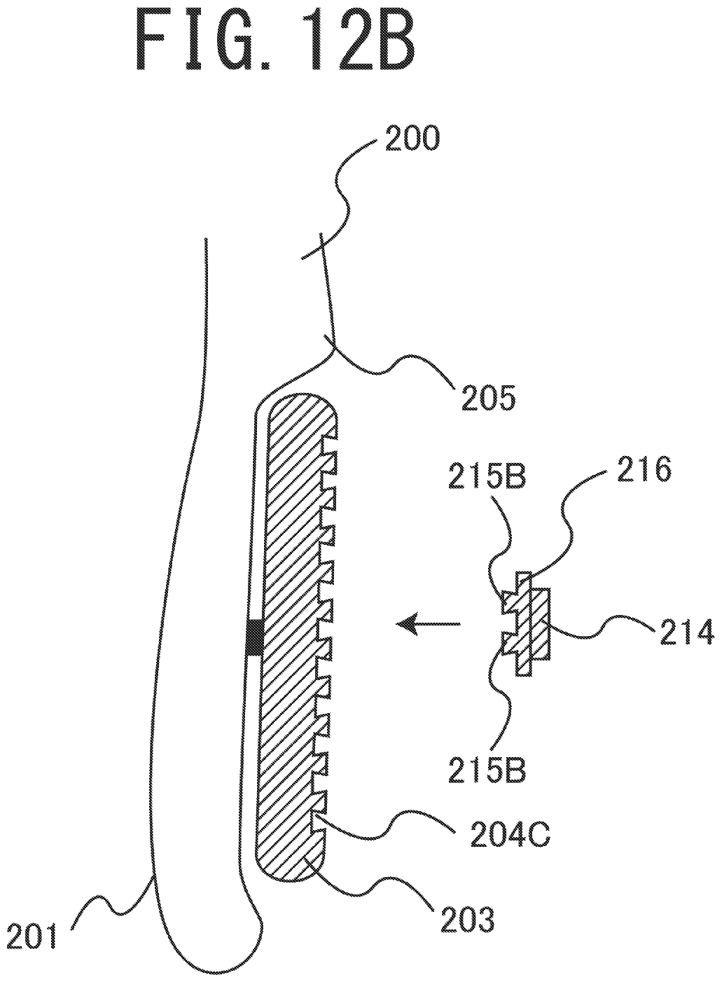

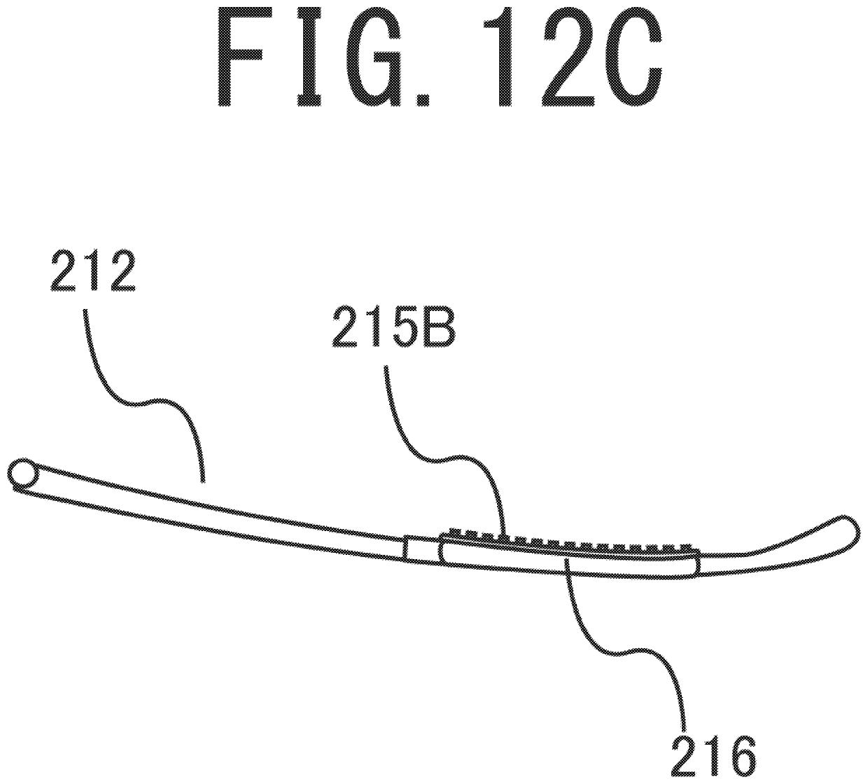

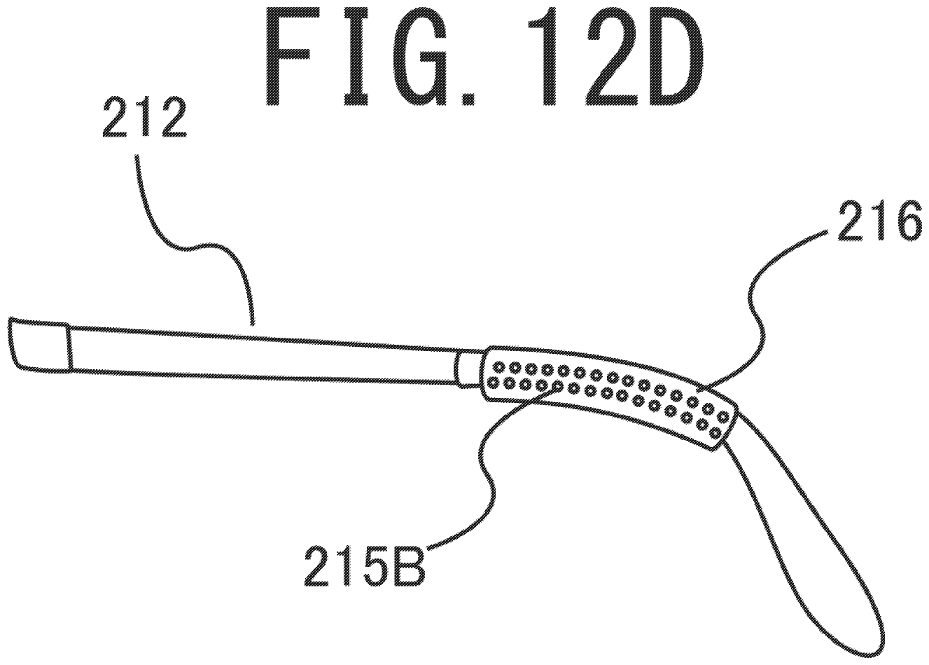

FIGS. 12A to 12D are views (No. 2) illustrating an example of a modification of the eyeglasses support member 200 according to a second embodiment.

### Third Modification

FIG. 12A is a view illustrating a third modification of the eyeglasses support member 200 according to the second embodiment. The connecting member 203 in the third modification has a fitting portion 204B. The fitting portion 204B differs from the fitting portion 204A in that it does not have a recess on the bottom surface. The temple tip 214 of general eyeglasses 2 may be fitted into the fitting portion 204B.

### Fourth Modification

FIG. 12B is a view illustrating a fourth modification of the eyeglasses support member 200 according to the second embodiment. The connecting member 203 in the fourth modification has a plurality of hole-shaped fitting portions 204C. Moreover, the eyeglasses 2 in the fourth modification has attachments 216 on the arm portions 212. As an example, the attachment 216 is removable with respect to the arm portion 212. The installation method for installing the attachment 216 on the arm portion 212 is not limited. The attachment 216 has a plurality of protrusions 215B.

The arm portion 212 and the connecting member 203 are connected by fitting a part of the plurality of protrusions 215B in the fitting portions 204C. As an example, the attachment 216 and the protrusions 215B are integrally molded with resin and fitted to the fitting portions 204C of the connecting member 203 formed of resin. Moreover, the fitting portions 204C and the protrusions 215B are formed so as to engage with each other. As an example, the protrusions 215B have a trapezoidal cross-sectional shape with the dimension in the height direction of the tip end being greater then the base, and the fitting portions 204C have a shape that fits into the protrusions 215B having the shape described above.

### Third Embodiment

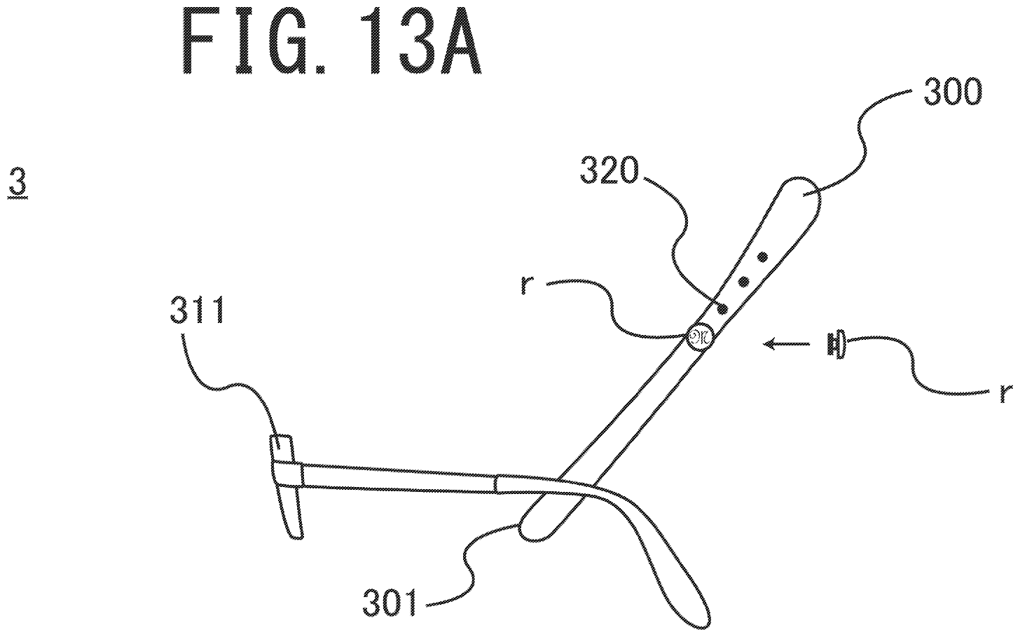

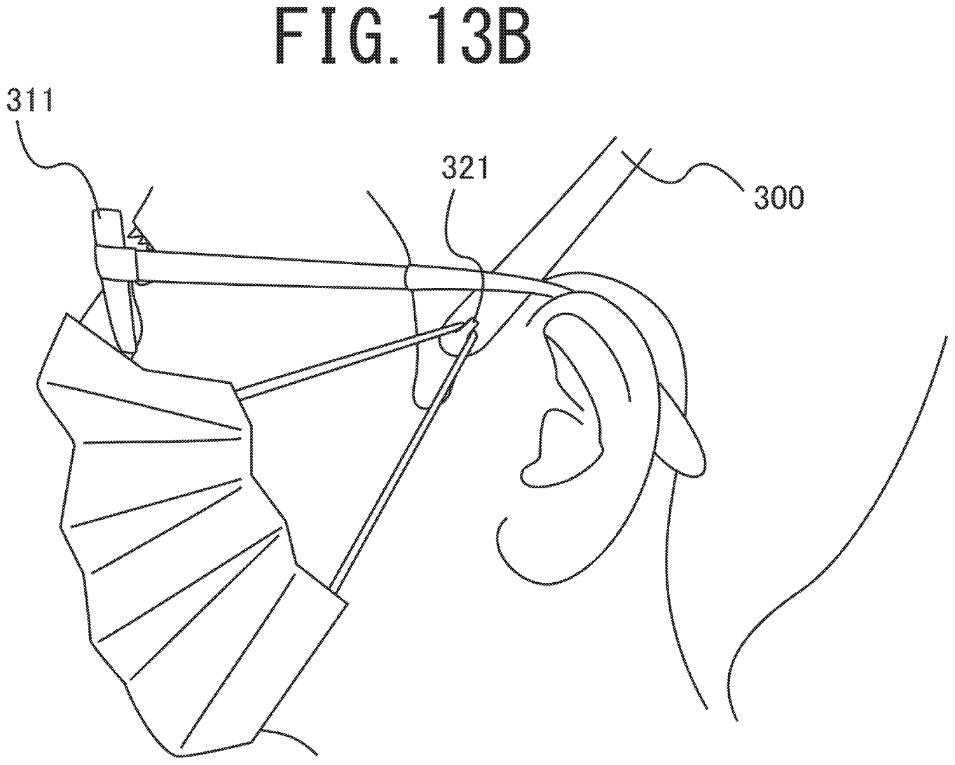

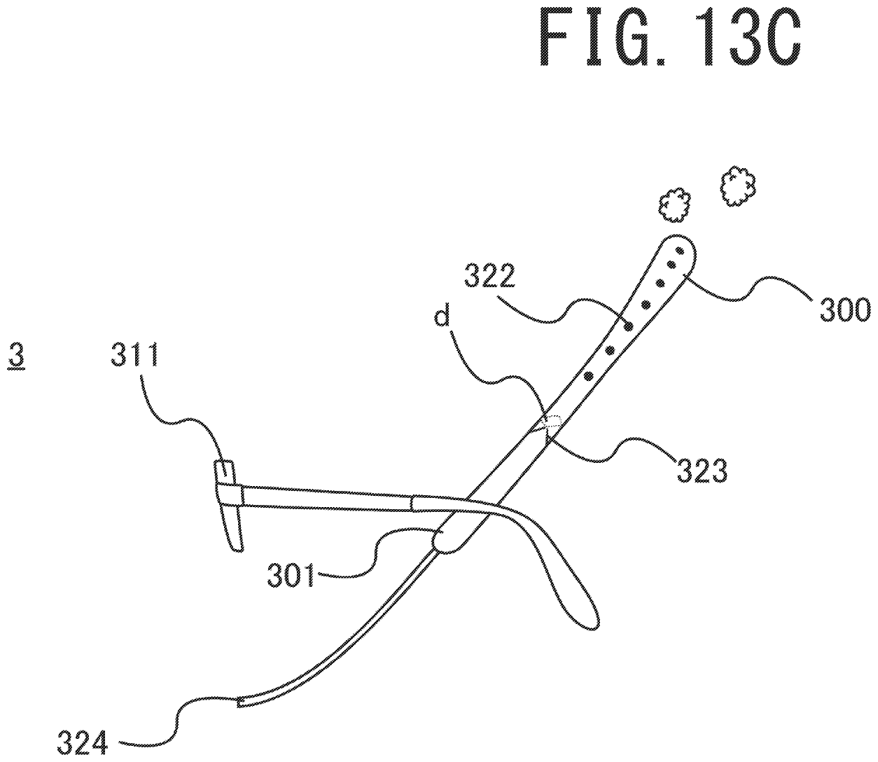

FIGS. 13A to 13C are views illustrating an example of the appearance of eyeglasses 3 according to a third, fourth and fifth embodiment. FIG. 13A is an example of a right side view of the eyeglasses 3 according to a third embodiment. The eyeglasses support member 300 of the eyeglasses 3 in the third embodiment have recesses 320 on the outer side. The recess 320 may be through holes.

An accessory r having a protrusion may be connected to the recess 320. The protrusion may have a barb, and the accessory r may be fixed to the eyeglasses support member 300 by fitting the protrusion into the recess 320. The accessory r is, for example, a decorative accessory and may decorate the eyeglasses support member 300.

### Fourth Embodiment

FIG. 13B is a diagram showing an example of using the eyeglasses 3 in a fourth embodiment. FIG. 13B illustrates a part of the eyeglasses support member 300 and the eyeglasses 3 that are located on the left side when viewed from the user. A set of eyeglasses support members 300 have hook-shaped members 321 that are pointed upward and toward the rear on the surface of the opposite side of the zygomatic arch contact portions 301. As illustrated in FIG. 13B, the hook-shaped member 321 can secure the elastic band portions of a mask.

In a conventional mask, the cloth portion may be applied to the nose and mouth by putting two elastic band portions on the left and right ears, but the elastic force of the elastic band portions may hurt the ears. By attaching the elastic band portions to the hook-shaped members 321 in the first modification, the mask may be worn without putting a burden on the ears.

### Fifth Embodiment

FIG. 13C is an example of a right side view of the eyeglasses 3 according to a fifth embodiment. The eyeglasses support member 300 in the second modification is a set of hollow long, thin members, and by opening and closing a part thereof, contents may be put into the hollow portion.

Moreover, the eyeglasses support member 300 in the second modification has holes 322, a barb 323, and a tube 324. The holes 322 are holes formed in the outer surface of the eyeglasses support member 300, and air inside the eyeglasses support member 300 can be taken in and out. The barb 323 is provided on the inner portion of the eyeglasses support member 300 to prevent the contents from falling downward. FIG. 13C illustrates how the barb 323 holds dry ice d placed inside the eyeglasses support member 300.

The tube 324 is a hollow tube, one end of which is connected to the hollow portion of the eyeglasses support member 300. The other end of the tube 324 extends to a position reaching the user's mouth. The user can breathe through the tube 324 and the eyeglasses support member 300 by holding the end of the tube 324.

When dry ice d is put inside the eyeglasses support member 300 and air is blown from the tube 324, CO2 vaporized from the dry ice d is ejected from the hole 322. This is especially useful when desiring to create an interesting appearance.

In addition, for example, the gas emitted from the contents of the eyeglasses support member 300 may be sucked in. For example, chopped tobacco can be placed inside and inhaled. Furthermore, for example, by adding a solid chemical, the vaporized chemical can be inhaled.

### Sixth Embodiment

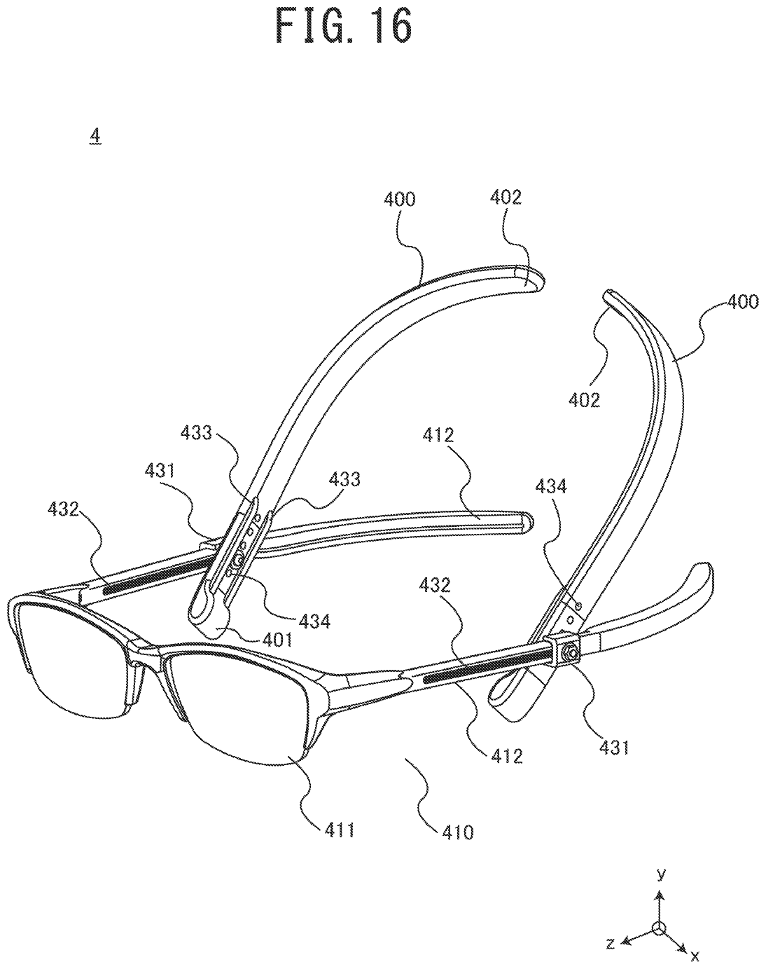

FIG. 16 is a view illustrating an example of a perspective view of eyeglasses 4 according to a sixth embodiment. The eyeglasses 4 have eyeglasses support members 400 and an eyeglasses main body portion 410. The eyeglasses main body portion 410 has a front portion 411 and arm portions 412. In the arm portions 412 illustrated in FIG. 16, the temple tip and the temple are integrated; however, as in the other embodiments described above, the temple tip and the temple may be connected to form the arm portion 412. The eyeglasses support members 400 have a zygomatic arch contact portion 401 and a parietal bone support portion 402, as in the other embodiments described above.

The arm portions 412 in this sixth embodiment have a fixing member 431, a slit 432, a plurality of contact members 433, and one or a plurality of through holes 434. The slit 432 is provided so as to extend in the longitudinal direction of the arm portion 412.

The eyeglasses support members 400 are fixed at an arbitrary position in the longitudinal direction of the arm portion 412 by the fixing member 431 penetrating the slit 432. In other words, by changing the fixed position by the fixing member 431, the position of the eyeglasses support members 400 in the front-back direction (z direction) with respect to the eyeglasses main body portion 410 may be adjusted.

In addition, the fixing member 431 fixes the eyeglasses support member 400 to the arm portion 412 by penetrating through the through hole 434 of the eyeglasses support member 400 and the slit 432. In a case where the eyeglasses support member 400 has a plurality of through holes 434, the vertical position of the eyeglasses support member 400 with respect to the eyeglasses main body portion 410 may be adjusted by the fixing member 431 penetrating through different through holes 434 and fixing the eyeglasses support member 400.

Moreover, the eyeglasses support member 403 has a plurality of contact members 433 protruding in the width direction (x-axis direction in FIG. 16) on the inside thereof. The contact members 433 protrudes further than the protrusion height in the width direction (inside) of the fixing member 431, and prevents the fixing member 431 from coming into contact with the skin. In this example, the eyeglasses support member 400 is fixed by the fixing member 431 having a screw head on the inside; however, preferably the contact members 433 are provided on both sides of the screw head (or in other words, the through holes 434) so that the screw head does not come into direct contact with the skin.

Note that the contact members 433 illustrated in FIG. 16 are long, thin members that extend along the longitudinal direction of the eyeglasses support member 400; however, the shape of the contact members 433 is not limited to this, as long as the contact members 433 protrude so as to prevent the fixing member 431 from coming in contact with the skin. For example, the contact members 433 may be a plurality of continuous protrusions connected to both sides of the through holes 434. In this case, the contact members 433 may be configured so that a pair of protrusions face each other via one through hole 434 for one or a plurality of the through holes 434 of the eyeglasses support member 400.

Note that in the eyeglasses support member 403, instead of providing the contact members 433, recesses having a depth for embedding the screw head may be provided on the peripheral edges of the through holes 434. In this case, preferably recesses are provided so that the inner surface of the eyeglasses support member 403 and the surface of the screw head are flush with each other as much as possible.

Note that the arm portion 412 may have a plurality of through holes that are continuously arranged in the longitudinal direction instead of the slit 432. By inserting the fixing member 431 through different through holes, the eyeglasses support member 400 may be fixed at an arbitrary position in the longitudinal direction of the arm portion 412, as in the case of using the slit 432.

Moreover, the eyeglasses support member 400 may have a protrusion that penetrates the slit 432 instead of the through holes 434. The eyeglasses support member 400 may be fixed to the arm portion 412 by using a nut-shaped or cap-shaped member having a diameter larger than the width of the slit 432 with respect to the protrusion penetrating the slit 432.

Note that as illustrated in FIG. 16, the eyeglasses support member 400 may be fixed to the inner side of the arm portion 412 or may be fixed to the outer side of the arm portion 412.

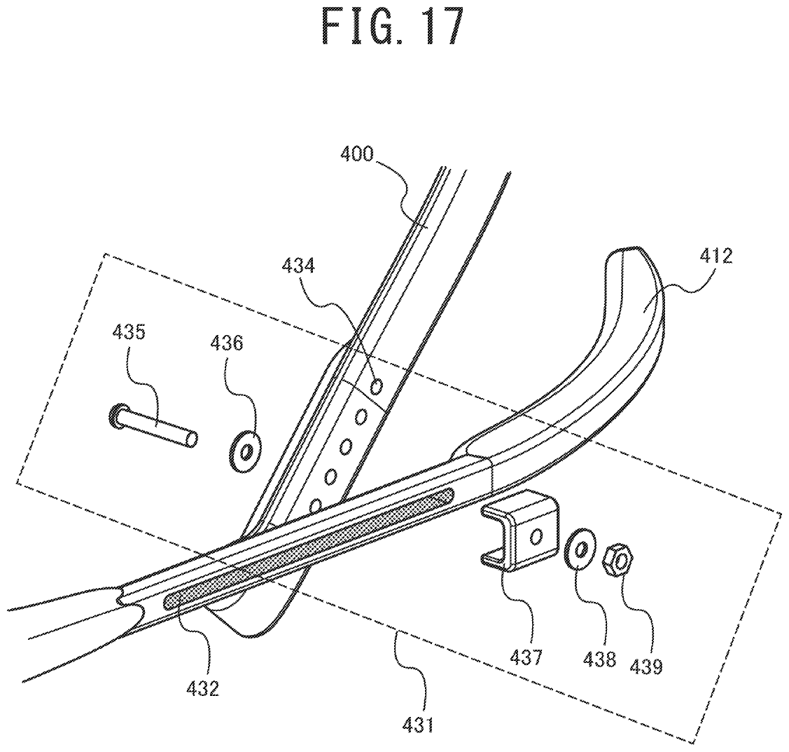

FIG. 17 is a view for explaining an example of a fixing member 431. The fixing member 431 has a screw 435, washers 436 and 438, a cover part 437, and a nut 439. The cover part 437 is a member that covers a part of the arm portion 412. As illustrated in FIGS. 16 and 17, when the eyeglasses support member 400 is fixed to the inside of the arm portion 412, the screw 435 is inserted from the inner side of the eyeglasses support member 400 via the washer 436 and through the through hole 434, the slit 432, and the cover part 437 in that order. The eyeglasses support member 400 is fixed to the arm portion 412 by placing the washer 438 over the tip of the screw 435 that has been inserted through the through hole of the cover part 437 and then tightening the nut 439.

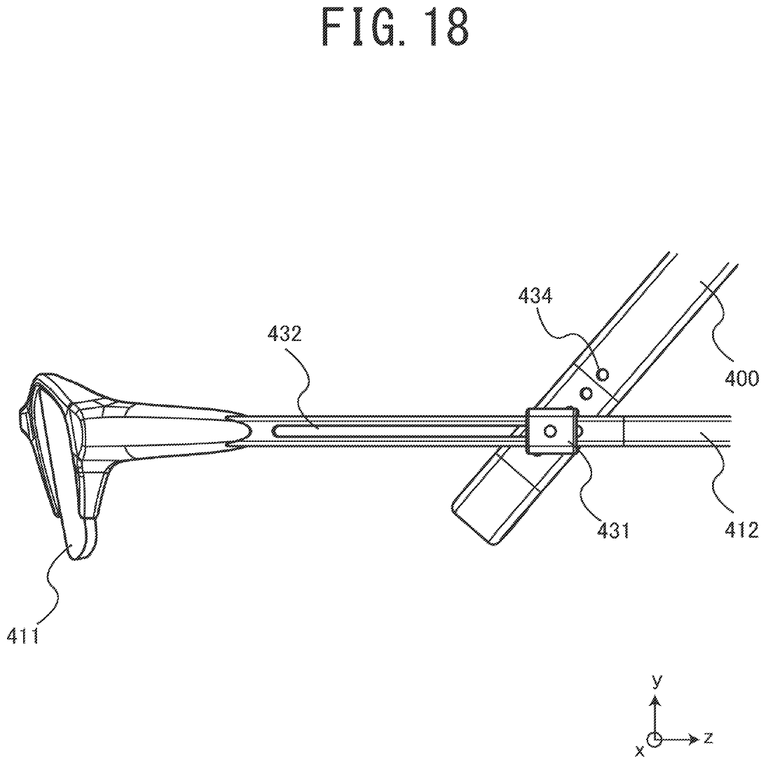

FIG. 18 is a view illustrating an example of a right side view of a part of the eyeglasses 4 according to a sixth embodiment. In this figure, the notations for the washer 438 and the nut 439 are omitted. The slit 432 penetrates through the structure so that the position of the eyeglasses support member 400 in the front-back direction (z direction) with respect to the arm portion 412 may be adjusted.

Note that in the eyeglasses 4 according to the sixth embodiment, preferably the center of gravity of the eyeglasses 4 comes near the connecting portion between the eyeglasses support member 400 and the arm portion 412. Compared to eyeglasses having a center of gravity in the vicinity of the front portion 411, the eyeglasses 4 are well balanced when worn on the head, and the eyeglasses 4 may be stably supported on the head.

### First Modification

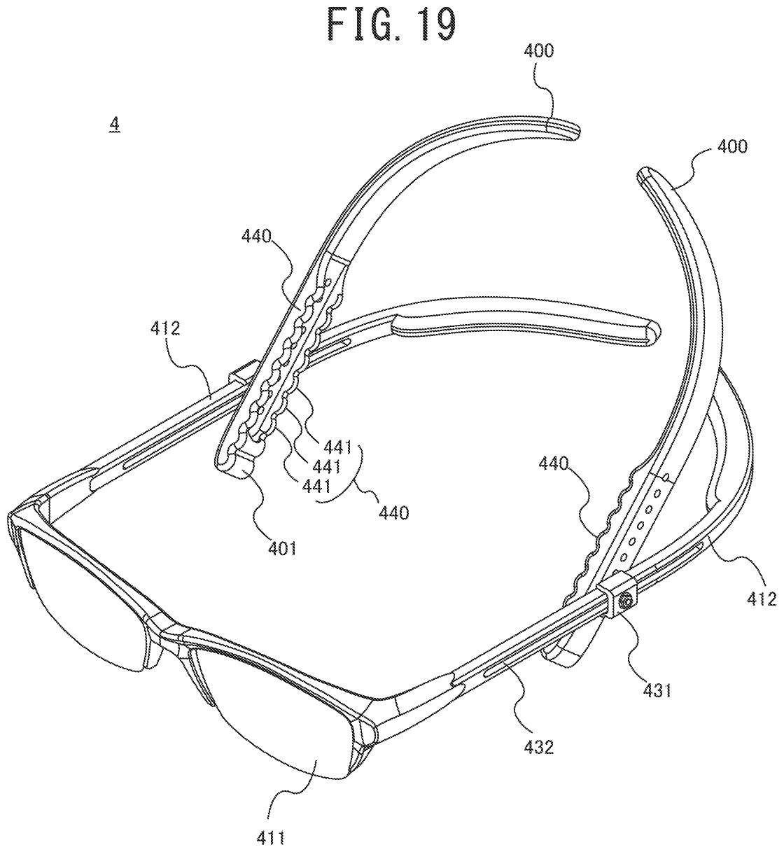

FIG. 19 is a view illustrating an example of a perspective view of the eyeglasses 4 in a first modification of a sixth embodiment. The eyeglasses support members 400 in this modification have a plurality of contact members 440 ion the inner side thereof. The contact members 440 have a plurality of protrusions 441 that are continuously arranged in the longitudinal direction of the eyeglasses support member 400.

Similar to the above-mentioned contact members 433, the contact members 440 protrude further in the width direction than the protrusion height of the fixing member 431 in order to prevent the fixing member 431 from touching the skin. The protrusions 441 are continuously arranged in the longitudinal direction of the eyeglasses support member 400 in order to prevent the eyeglasses support member 400 and the zygomatic arch contact portion 401 from being displaced. As illustrated in FIG. 19, for example, the protrusions 441 have a semicircular shape when the eyeglasses 4 are viewed from the front, and by engaging with the skin and hair near the temples, it is possible to prevent the eyeglasses support member 400 from moving in the vertical direction and in the front-back direction.

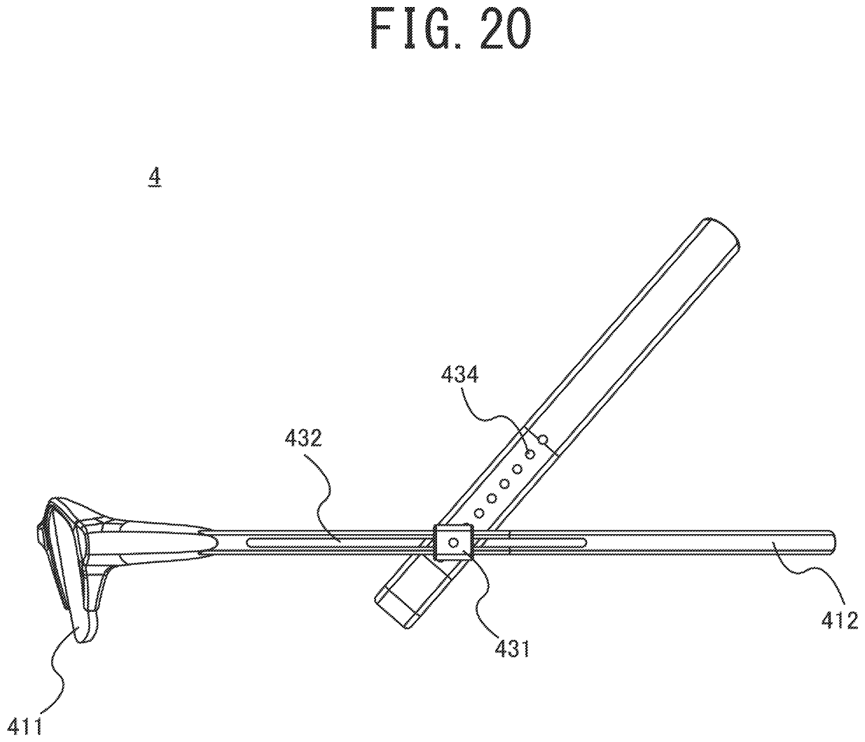

FIG. 20 is a view illustrating an example of a right side view of a part of the eyeglasses 4 in a first modification of this sixth embodiment. The slit 432 in this modification is different from the sixth embodiment (see FIG. 18) in that it extends to the temple portion. Note that the length of the slit 432 is not limited to the examples shown in FIGS. 18 and 20, and the slit 432 may extend to the vicinity of the end (right end in FIG. 20) opposite to the front portion 411 of the arm portion 412, for example.

### Second Modification

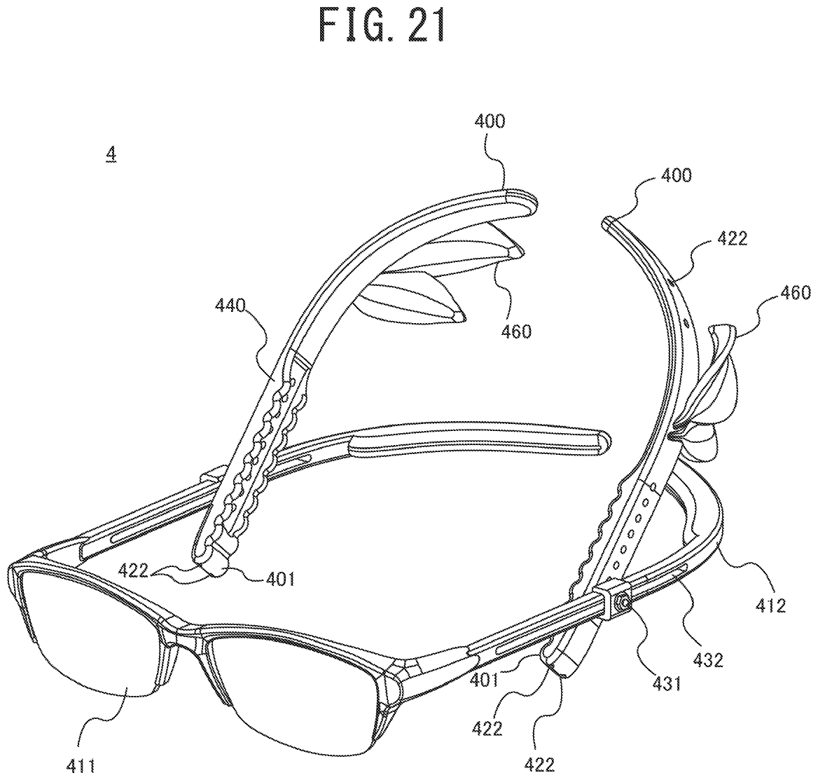

FIG. 21 is a view illustrating an example of a perspective view of the eyeglasses 4 in a second modification of this sixth embodiment. The eyeglasses support members 400 in this modification have opening portions 422 and decorative members 460. The opening portion 422 is one or more holes drilled in the outer surface of the eyeglasses support member 400 and is connected to a cavity inside the eyeglasses support member 400 and is able to allow air to flow in and out of the cavity. In other words, the opening portion 422 has the same function as the holes 322 of the fifth embodiment (see FIG. 13C) described above.

Moreover, the eyeglasses support member 400 in this modification has one or a plurality of decorative members 460. The decorative member 460, in at least in part thereof, has a curved shape along the user's head. The decorative member 460 illustrated in FIG. 21 has the shape of a leaf, and the vicinity of the main vein is curved inward along the head.

Note that the decorative member 460 illustrated in FIG. 21 is connected to the outer surface of the eyeglasses support member 400 and is provided so as to extend toward the rear of the user. However, the connection position of the decorative member 460 to the eyeglasses support member 400 is not limited to this, and may be, for example, the rear side surface, the front side surface, or the inner side surface of the eyeglasses support member 400. The decorative member 460 may be provided so as to extend toward the front of the user.

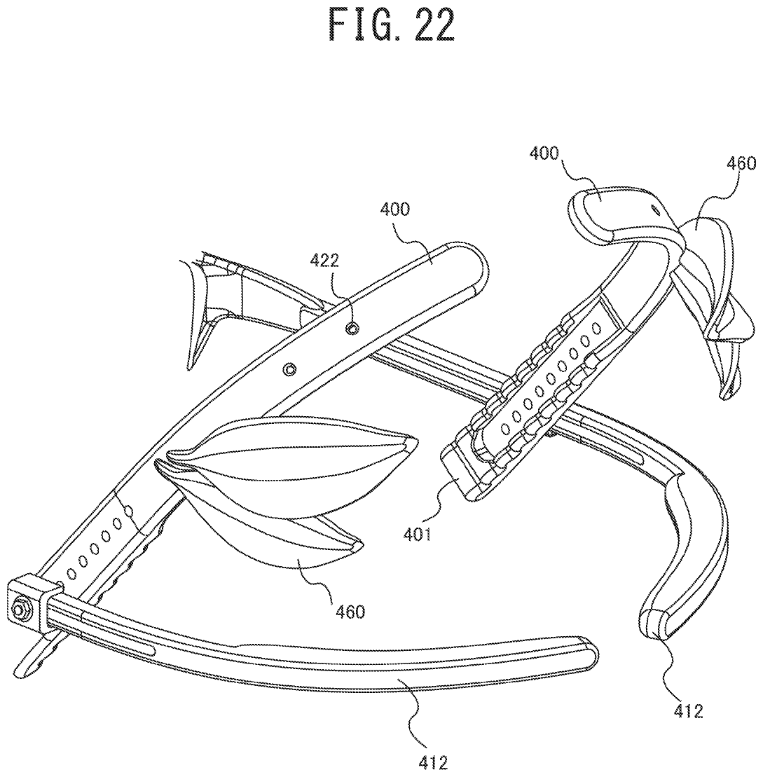

FIG. 22 is a view for explaining the eyeglasses support member 400 in a second modification of this sixth embodiment. This figure is an example of a view of a part of the eyeglasses 4 in a second modification of this sixth embodiment as viewed diagonally toward the right from the rear.

The decorative member 460 illustrated in FIG. 22 has an appropriate thickness and is integrated so as to bite into the eyeglasses support member 400. With this configuration, the contact surface with the head can be widened and friction is generated, so that the eyeglasses support member 400 may be prevented from shifting. Moreover, the load of the eyeglasses 4 exerts an outward force on the decorative member 460, and with this configuration the strength of the decorative member 460 increases.

Note that the accessory r in the third embodiment illustrated in FIG. 13A may function as the decorative member 460 in this example by being configured to come into contact with the head.

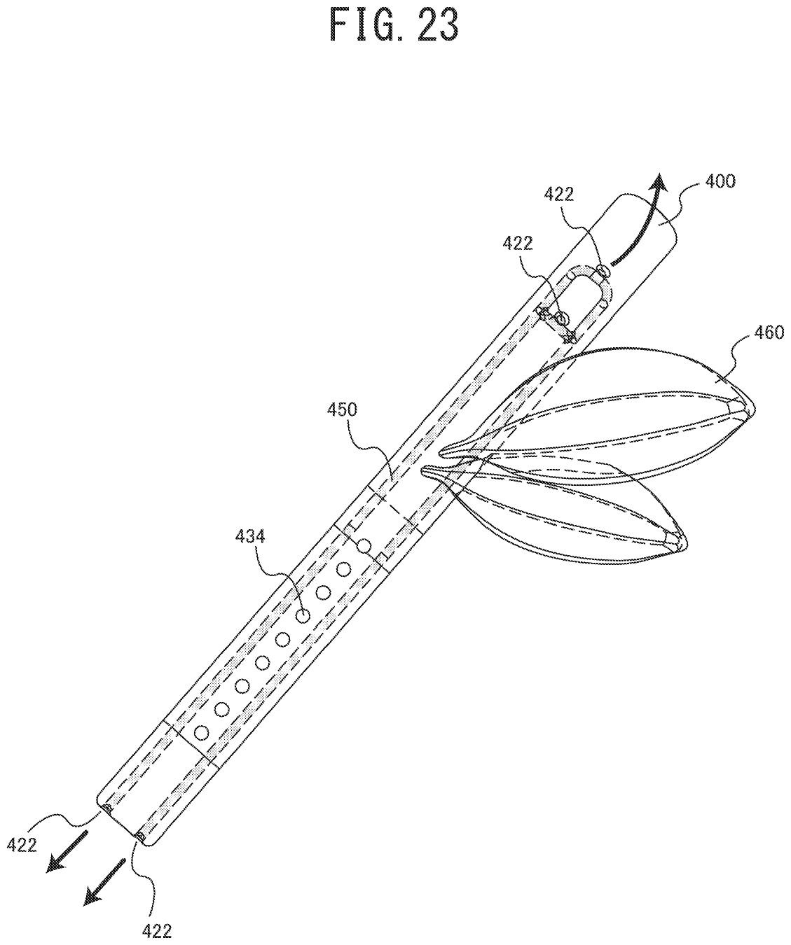

FIG. 23 is a view for explaining the inside of the eyeglasses support member 400 in a second modification of the sixth embodiment. The eyeglasses support member 400 has a tubular cavity 450 in the inner portion thereof. The cavity 450 has one or a plurality of opening portions 422 that open to the surface on the outer side of the eyeglasses support member 400, and the air in the inner portion is ventilated through the openings 422.

The eyeglasses support member 400 illustrated in FIG. 23 has four opening portions 422, and two opening portions 422 are provided near the zygomatic arch contact portion 401 and near the lower part of the eyeglasses support member 400. In addition, the other two opening portions 422 are provided on the surface of the outer side of the eyeglasses support member 400 near the crown of the head. The cavity 450 is substantially U-shaped and connects to each of the opening portions 422. For example, as in the fifth embodiment (see FIG. 13C), a hollow tube (not illustrated) extending to the mouth of the user is connected to the lower opening portions 422 of the eyeglasses support member 400, making it possible to breathe through the cavity 450 and the tube.

Note that by putting contents inside the tube, the user can suck in the gas emitted from the contents and discharge the gas from the opening portions 422, as in the fifth embodiment.

Furthermore, the cavity 450 in FIG. 22 is not connected to the through holes 434 for fixing the eyeglasses support member 400 to the arm portion 412, and the gas inside the cavity 450 is not produced from the through hole 434. However, the cavity 450 and the through holes 434 may be connected.

As described above, the eyeglasses according to the present embodiment by having eyeglasses support members, the load of the eyeglasses can be appropriately distributed on the contact surface between the zygomatic arch contact portion and the temporal region, the contact surface between the parietal bone support portion and the parietal bone, and the contact surface between the temple tip and the ear. Moreover, the eyeglasses can be supported from above by the parietal bone support portion, so the burden on the side surface of the head can be reduced as compared with the conventional technique of supporting the eyeglasses from only the left and right side surfaces of the head.

In other word, in a case where the support member extends to the vicinity of the zygomatic bone, design restrictions are unavoidable, such as making the support member a smooth shape in order to reduce the burden on the skin of the face. The eyeglasses are supported by pressing against and holding onto the head, so when uneven portions are added to the support members so that the eyeglasses do not slide down, not only will marks be left when the eyeglasses are removed, but there is also a possibility that the skin of the face will be damaged unexpectedly. In addition, it is necessary to consider the burden on the skin of the face because of sweating at the contact locations with the support members.

In the eyeglasses according to the present embodiment, the zygomatic arch contact portion does not extend to the vicinity of the eye, so the degree of freedom in shape is increased. For example, even when the zygomatic arch contact portion is provided with irregularities in order to prevent the zygomatic arch contact portion from sliding downward, the zygomatic arch contact portion is located at a less conspicuous place, so that the effect on the appearance is small.

In particular, in the present embodiment, the location where the zygomatic arch contact portion comes in contact is close to the position where a hairpin or the like is fastened, so the size and thickness of the hair ornament can be adopted. Even when sweating, the influence on the appearance can be reduced as compared with the case where the support member comes into contact with the skin of the face.

Although embodiments and modifications according to the present invention have been described above, the present invention is not limited to the above-described embodiments, and various modifications are included. For example, an example of the above-described embodiment has been described in detail for the sake of clarity of the present invention, and the present invention is not limited to an invention having all the configurations described here. Moreover, it is possible to replace a part of the configuration of one example of a certain embodiment with the configuration of another example. In addition, it is also possible to add the configuration of another example to the configuration of one example of one embodiment. Furthermore, it is possible to add, delete or replace a part of the configuration of one example of each embodiment with another configuration.

### REFERENCE SIGNS LIST

1, 2, 3, 4, 8, 9: Eyeglasses

100, 200, 300, 400: Eyeglasses support member

101, 201, 301, 401: Zygomatic arch contact portion

102, 202, 302, 402: Parietal bone support portion

103, 434: Through hole

104: Protrusion

110, 210, 410: Eyeglasses main body portion

111, 411, 811, 911: Front portion

112, 212, 412, 812, 912: Arm portion

113. 213, 813, 913: Temple

114, 214, 314, 814, 914: Temple tip

115: Recess

203: Connecting member

204, 204A, 204B, 204C: Fitting portion

205: Protrusion

206: Covering portion

207A: Recess

215A, 215B: Protrusion

216: Attachment

320: Recess

321: Hook-shaped member

322, 422: Hole

323: Barb

324: Tube

431: Fixing member

432: Slit

433 440: Contact member

435: Screw

436, 438: Washer

437: Cover part

439: Nut

441: Protrusion

450: Cavity

460: Decorative member

d: Dry ice

e, f: Attachment portion

r: Accessory

1. Eyeglasses comprising:
a front portion having lenses;
a pair of arm portions extending substantially perpendicularly from both ends of the front portion;
a pair of eyeglasses support members connected to each of the arm portions:
each of the pair of eyeglasses support members having
a zygomatic arch contact portion that comes in contact with a temporal region so as to engage with a zygomatic arch; and
a parietal bone support portion that comes in contact with a position on an outer side of the parietal bone and supports the eyeglasses from above.

2. The eyeglasses according to claim 1, wherein
each of the pair of eyeglasses support members is composed of a long, thin member having the zygomatic arch contact portion at one end and the parietal bone support portion at the other end, and extends diagonally from below to above the arm portion and from the front to the back of the head.

3. The eyeglasses according to claim 2, wherein
the pair of eyeglasses support members are connected to each other at each of the parietal bone support portions.

4. The eyeglasses according to claim 1, further comprising
connecting members that connect the arm portions and the eyeglasses support members; wherein
each connecting member has a plurality of fitting portions, and one of the fitting portions and the arm portion are detachably fitted.

5. The eyeglasses according to claim 1, further comprising
connecting members that connect the arm portions and the eyeglasses support members; wherein
each connecting member is rotatably provided with respect to the eyeglasses support member.

6. The eyeglasses according to claim 4, wherein
each eyeglasses support member has a protrusion on an upper side of the connecting member that protrudes further in a width direction than the connecting member.

7. The eyeglasses according to claim 4, wherein
each eyeglasses support member has a covering portion that covers at least a part of an outer surface of the connecting member.

8. The eyeglasses according to claim 4, wherein
each arm portion has a detachable member that fits into a fitting portion provided on the connecting member.

9. The eyeglasses according to claim 1, wherein
each eyeglasses support member has a hook-shaped member on a surface opposite to the zygomatic arch contact portion.

10. Eyeglasses support members that connect to arm portions of eyeglasses, comprising:
a zygomatic arch contact portion that comes in contact with a temporal region so as to engage with a zygomatic arch; and
a parietal bone support portion that comes in contact with a position on an outer side of the parietal bone and supports the eyeglasses from above.

11. The eyeglasses according to claim 1, wherein
each arm portion has a slit extending in a longitudinal direction or a plurality of through holes continuously arranged in the longitudinal direction; and
each eyeglasses support member is fixed at an arbitrary position in a longitudinal direction of the arm portion by a fixing member penetrating through the slit or the through hole.

12. The eyeglasses according to claim 11, wherein
each eyeglasses support member has a plurality of contact members on the inner side and protruding in the width direction.

13. The eyeglasses according to claim 12, wherein
each contact member has a plurality of protrusions continuously arranged in the longitudinal direction of the eyeglasses support member.

14. The eyeglasses according to claim 12, wherein
each contact member protrudes further in the width direction toward the inner side of the eyeglasses support member than the protrusion height of the fixing member.

15. The eyeglasses according to claim 1, wherein
each eyeglasses support member is provided with a cavity inside; and
the cavity has one or more opening portions that open on an outer side surface of the eyeglasses support member.

16. The eyeglasses according to claim 1, wherein
the eyeglasses support members have one or more decorative members; and
the decorative member has, at least in part, a curved shape along the head.
